(19) United States
(12) Patent Application Publication
(10) Pub. No.: US 2026/0239463 A1
(43) Pub. Date: Aug. 13, 2026

(54) METHOD AND DEVICE FOR CONFIGURATION REPORTING

(71) Applicant: Samsung Electronics Co., Ltd., Suwon-si, Gyeonggi-do (KR)

(72) Inventors: Xingyu HAN, Beijing (CN); Dingye ZHANG, Beijing (CN)

(21) Appl. No.: 19/126,164

(22) PCT Filed: Oct. 25, 2023
(86) PCT No.: PCT/KR2023/016655

§ 371 Date: Apr. 30, 2025

(30) Foreign Application Priority Data
Nov. 2, 2022 (CN) 202211364918.5
Mar. 30, 2023 (CN) 202310334587.9

(51) Int. Cl. H04W 76/15; H04L 5/00; H04L 41/5067; H04W 24/10

(52) U.S. Cl. CPC H04W 76/15; H04L 5/0053; H04L 41/5067; H04W 24/10

(57) ABSTRACT

The disclosure relates to a 5G or 6G communication system for supporting a higher data transmission rate. The present disclosure provides a method performed in a wireless communication system and a device thereof. In one embodiment, a method performed by a first node is disclosed, the method comprising: transmitting a first message to a second node, the first message comprising first information, and the first information comprising first indication information related to a reporting link/path of Quality of Experience report(s); and receiving a first response message from the second node in response to the first message.

### TECHNICAL FIELD

The present application relates to wireless communication technology, and in particular, to a method and device for configurating and reporting configuration information related to Quality of Experience.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

In order to meet an increasing demand for wireless data communication services since a deployment of 4G communication system, efforts have been made to develop an improved 5G or pre-5G communication system. Therefore, the 5G or pre-5G communication system is also called “beyond 4G network” or “post LTE system.”

Wireless communication is one of the most successful innovations in modern history. Recently, a number of subscribers of wireless communication services has exceeded 5 billion, and it continues growing rapidly. With the increasing popularity of smart phones and other mobile data devices (such as tablet computers, notebook computers, netbooks, e-book readers and machine-type devices) in consumers and enterprises, a demand for wireless data services is growing rapidly. In order to meet rapid growth of mobile data services and support new applications and deployments, it is very important to improve efficiency and coverage of wireless interfaces.

With the gradual maturity of 5G commercial network (NR: New Radio access network), the application area of the technology of QoE (Quality of Experience) for the user is also expanding, and in order to better improve user experience, the research and standardization related thereto are also underway.

### DISCLOSURE OF INVENTION

### Solution to Problem

According to one aspect of the present disclosure, there is provided a method performed by a first node in a wireless communication system, the method comprising: transmitting a first message to a second node, the first message comprising first information, and the first information comprising first indication information related to a reporting link/path of Quality of Experience (QoE) report(s); and receiving a first response message from the second node in response to the first message.

In a further embodiment, the first information comprises at least one of the following information: a QoE reference or QoE reference ID; an application layer configuration ID; a measurement collection entity IP address; a measurement collection entity ID; and a switching direction of the reporting link/path.

In a further embodiment, the first indication information comprises at least one of the following information: information indicating the QoE report is reported by a master node or a secondary node; information indicating whether the QoE report is reported by the master node; information indicating whether the QoE report is reported by the secondary node; and information indicating the reporting link/path of the QoE report is requested/required to be switched.

In a further embodiment, the response message comprises at least one of the following information: information of acknowledging/confirming the QoE report is reported by the master node or the secondary node; information of acknowledging/confirming the QoE report is reported by the master node; information of acknowledging/confirming the QoE report is reported by the secondary node; and information of acknowledging/confirming switching of the reporting link/path of the QoE report.

In a further embodiment, the first message comprises at least one of the following: a message for requesting to add the second node or a message for requesting to modify the second node.

In a further embodiment, the first response message comprises a message for acknowledging/confirming the requesting to add the second node or a message for acknowledging/confirming the request of modifying the second node.

In a further embodiment, the method further comprises:
transmitting a fourth message to a third node, wherein the fourth message comprises fifth information, and wherein the fifth information comprises eighth indication information related to the QoE report.

In a further embodiment, the eighth indication information comprises at least one of the following information: information indicating the QoE report is reported by the master node or the secondary node; information indicating whether the QoE report is reported by the master node; information indicating whether the QoE report is reported by the secondary node; and information indicating switching of the reporting link/path of the QoE report.

In a further embodiment, the fifth information comprises node information, wherein the node information is used to indicate a reporting node to which a terminal is requested/required to be switched.

In a further embodiment, the fourth message comprises a radio resource control (RRC) reconfiguration message.

In a further embodiment, the first node is a master base station/master node, or a centralized unit of the master base station/master node, or control plane part of the centralized unit of the master base station/master node, and the second node is a secondary base station, a secondary node, or a centralized unit of the secondary base station/secondary node, or control plane part of the centralized unit of the secondary base station/secondary node.

According to another aspect of the present disclosure, there is provided a method performed by a second node in a wireless communication system, the method comprising: receiving a first message from a first node, the first message comprising first information, and the first information comprising first indication information related to a reporting link/path of Quality of Experience (QoE) report(s); and transmitting a response message in response to the first message to the first node.

According to another aspect of the present disclosure, there is provided a method performed by a first node in a wireless communication system, the method comprising: receiving a fifth message from a second node, the fifth message comprising third information, and the third information comprising seventh indication information related to a Quality of Experience (QoE) measurement; and transmitting a second response message in response to the fifth message to the second node.

In a further embodiment, the third information further comprises at least one of the following information: a QoE reference or QoE reference ID; an application layer configuration ID; a measurement collection entity Internet Protocol (IP) address; a measurement collection entity ID; and a switching direction of the reporting link/path.

In a further embodiment, the seventh indication information comprises at least one of the following information: information indicating the QoE report is reported by a master node or a secondary node; information indicating whether the QoE report is reported by the master node; information indicating whether the QoE report is reported by the secondary node; and information indicating the reporting link/path of the QoE report is requested/required to be switched.

In a further embodiment, the second response message comprises at least one of the following information: information of acknowledging/confirming the QoE report is reported by the master node or the secondary node; information of acknowledging/confirming the QoE report is reported by the master node; information of acknowledging/confirming the QoE report is reported by the secondary node; and information of acknowledging/confirming switching of the reporting link/path of the QoE report.

In a further embodiment, the fifth message comprises a message for requiring modification of the second node.

In a further embodiment, the second response message comprises a message for acknowledging/confirming the modification of the second node.

In a further embodiment, the method further comprises: transmitting a fourth message to a third node, wherein the fourth message comprises fifth information, and wherein the fifth information comprises eighth indication information related to the QoE report.

In a further embodiment, the eighth indication information comprises at least one of the following information: information indicating the QoE report is reported by a master node or a secondary node; information indicating whether the QoE report is reported by the master node; information indicating whether the QoE report is reported by the secondary node; and information indicating switching of the reporting link/path of the QoE report.

In a further embodiment, the fifth information comprises node information, wherein the node information is used to indicate a reporting node to which a terminal is requested/required to be switched.

In a further embodiment, the fourth message comprises a radio resource control re-configuration message.

In a further embodiment, the first node is a master base station/master node, or a centralized unit of the master base station/master node, or control plane part of the centralized unit of the master base station/master node, and the second node is a secondary base station, a secondary node, or a centralized unit of the secondary base station/secondary node, or control plane part of the centralized unit of the secondary base station/secondary node.

According to another aspect of the present disclosure, there is provided a method performed by a second node in a wireless communication system, the method comprising: transmitting a fifth message to a first node, the fifth message comprising third information, and the third information comprising seventh indication information related to Quality of Experience (QoE) measurement; and transmitting from the first node a second response message in response to the fifth message.

According to another aspect of the present disclosure, there is provided a method performed by a first node in a wireless communication system, the method comprising: transmitting a second message to a second node, the second message comprising seventh information, wherein the seventh information comprises at least one of the following: configuration information of Quality of Experience (QoE) related parameters/metrics visible to radio access network and recommended/suggested configuration information of QoE related parameters/metrics visible to the radio access network; and receiving a third response message from the second node in response to the second message.

In a further embodiment, the seventh information further comprises at least one of the following: thirteenth information, which is used to request the configuration information of QoE related parameters/metrics visible to the radio access network; fourteenth information, which comprises at least one of a Protocol Data Unit (PDU) session ID, a PDU session list comprising at least one PDU session ID, a Quality of Service (QoS) flow ID and a QoS flow ID list comprising at least one QoS flow ID; PDU session related indication information, which comprises at least one of a PDU session ID, a PDU session list comprising at least one PDU session ID and second indication information, wherein the second indication information is used to indicate a PDU session corresponding to a PDU session ID or a PDU session list is at a master node or a secondary node; third indication information, which is used to indicate a master node has received or not received same configuration information of management-based QoE related parameters/metrics; a QoE reference or QoE reference ID; a service type; and fourth indication information, which is used to indicate a configuration of QoE visible to radio access network is provided by a master node or secondary node.

In a further embodiment, the configuration information of QoE related parameters/metrics visible to radio access network or recommended/suggested configuration information of QoE related parameters/metrics visible to the radio access network comprises at least one of the following information: an radio access network (RAN) visible periodicity, which is used to provide a reporting period of a QoE measurement visible to the radio access network; a buffer level indication, which is used to indicate that buffer level related parameter(s)/metric(s) is provided in the configuration, or that the buffer level related parameter(s)/metric(s) are configurable; number of buffer level entries; an indication of a playout delay for media startup, which is used to indicate parameter(s)/metric(s) related to the playout delay for media startup are provided in the configuration, or the parameter(s) /metric(s) related to the playout delay for media startup are configurable; and an indication of reporting the playout delay for media startup, which is used to indicate whether to report the playout delay for media startup.

In a further embodiment, the third response message comprises at least one of the following information: information of acknowledging/confirming a configuration of QoE visible to the radio access network; configuration information of QoE related parameters/metrics visible to the radio access network; and recommended/suggested configuration information of QoE related parameters/metrics visible to the radio access network.

In a further embodiment, the second message comprises a message for requesting to add a second node or a message for requesting to modify the second node.

In a further embodiment, the third response information comprises a message for acknowledging/confirming the requesting to add a second node or a message for acknowledging/confirming a request of modifying the second node.

In a further embodiment, the method comprises: receiving a sixth message from a fourth node, wherein the sixth message comprises sixth information, and wherein the sixth information comprises application layer related information.

In a further embodiment, the application layer related information comprises at least one of the following information: first association/mapping information, which is used to associate/map an application layer or an application layer session with a Protocol Data Unit session and/or QoS flow ID; wherein the first association/mapping information comprises at least one of the following messages: a Protocol Data Unit (PDU) session ID; a PDU session list, which comprises at least one PDU session ID; a Quality of Service (QoS) flow ID; and a QoS flow ID list, which comprises at least one QoS flow ID.

In a further embodiment, the sixth message comprises at least one of the following: a message requesting the first node to setup context and a message requesting the first node to modify the context.

In a further embodiment, the method further comprises: transmitting a seventh message to the second node, the seventh message comprising eleventh information, wherein the eleventh information comprises at least one of the following: acknowledging/confirming a configuration of QoE visible to the radio access network; and configuration related parameters/metrics of QoE visible to the radio access network.

In a further embodiment, the configuration related parameters/metrics of QoE visible to the radio access network comprise at least one of the following: a radio access network visible periodicity, which is used to provide a reporting period of a QoE measurement visible to the radio access network; a buffer level indication, which is used to indicate that a buffer level related parameter(s)/metric(s) are provided in the configuration, or that the buffer level related parameter(s)/metric(s) are configurable; number of buffer level entries; an indication of a playout delay for media startup, which is used to indicate parameter(s)/metric(s) related to the playout delay for media startup are provided in the configuration, or the parameter(s)/metric(s) related to the playout delay for media startup are configurable; and an indication of reporting the playout delay for media startup, which is used to indicate whether to report the playout delay for media startup.

In a further embodiment, the seventh message comprises a message for acknowledging/confirming completion of the reconfiguration to the second node.

According to another aspect of the present disclosure, there is provided a method performed by a first node in a wireless communication system, the method comprising: receiving a third message from a second node, the third message comprising ninth information, and the ninth information comprising at least one of the following: configuration information of Quality of Experience (QoE) related parameters/metrics visible to radio access network and recommended/suggested configuration information of QoE related parameters/metrics visible to the radio access network; and transmitting a fourth response message to the second node in response to the third message.

In a further embodiment, the ninth information further comprises at least one of the following: first request information, which is used to request the configuration information of QoE related parameters/metrics visible to the radio access network; PDU session related indication information, which comprises at least one of a PDU session ID, a PDU session list comprising at least one PDU session ID, and the ninth indication information, wherein the ninth indication information is used to indicate a PDU session corresponding to a PDU session ID or a PDU session list is at a master node or a secondary node; fifth indication information, which is used to indicate a master node has received or not received a same management-based configuration of QoE; a QoE reference or QoE reference ID; and a service type.

In a further embodiment, the configuration information of QoE related parameters/metrics visible to radio access network or recommended/suggested configuration information of QoE related parameters/metrics visible to the radio access network comprises at least one of the following information: a radio access network visible periodicity, which is used to provide a reporting period of a QoE measurement visible to the radio access network; a buffer level indication, which is used to indicate that buffer level related parameter(s)/metric(s) are provided in the configuration, or that the buffer level related parameter(s)/metric(s) are configurable; number of buffer level entries; an indication of a playout delay for media startup, which is used to indicate parameter(s)/metric(s) related to the playout delay for media startup are provided in the configuration, or the parameter(s)/metric(s) related to the playout delay for media startup is configurable; and an indication of reporting the playout delay for media startup, which is used to indicate whether to report the playout delay for media startup.

In a further embodiment, the tenth information comprises at least one of the following information: information of acknowledging/confirming a configuration of QoE visible to the radio access network; configuration related parameters/metrics of QoE visible to the radio access network; tenth indication information, which is used to indicate a master node has received or not received a same management-based configuration of QoE; and eleventh indication information, which is used to indicate a configuration of QoE visible to radio access network is provided by a master node or secondary node.

In a further embodiment, the third message comprises a message for requiring modification of the second node.

In a further embodiment, the fourth response message comprises a message for acknowledging/confirming the modification of the second node.

According to another aspect of the present disclosure, there is provided a method performed by a second node in a wireless communication system, the method comprising: transmitting a third message to a first node, the third message comprising ninth information, wherein the ninth information comprises at least one of the following: configuration information of Quality of Experience (QoE) related parameters/metrics visible to radio access network; and recommended/suggested configuration information of QoE related parameters/metrics visible to the radio access network; and receiving a fourth response message from the first node in response to the third message.

According to another aspect of the present disclosure, there is provided a method performed by a third node in a wireless communication system, the method comprising: receiving at least one of the following from a terminal application layer: at least one Protocol Data Unit (PDU) session and/or information related to at least one Quality of Service (QoS) flow; and
transmitting an eighth message to a first node or a second node, where the eighth message comprises twelfth information related to a Quality of Experience (QoE) report, and wherein the twelfth information comprises at least one of the following: at least one Protocol Data Unit (PDU) session and/or information related to at least one Quality of Service (QoS) flow.

In a further embodiment, the PDU session and/or information reated to the QoS comprise at least one of the following: a PDU session ID; a PDU session list, which comprises at least one PDU session ID; a QoS flow ID; and a QoS flow ID list, which comprises at least one QoS flow ID.

In a further embodiment, the twelfth information comprises sixth indication information for indicating that there is application layer session starting or ending.

In a further embodiment, the eighth message comprises a radio resource control reconfiguration message.

According to another aspect of the present disclosure, there is provided a method performed by a first node in a wireless communication system, the method comprising: triggering/initiating a procedure related to a node operation by the first node; and transmitting or receiving a ninth message, the ninth message comprising at least one of the following information: configuration information of Quality of Experience (QoE).

In a further embodiment, the method further comprises: transmitting a request of the configuration information of QoE.

In a further embodiment, the method further comprises: transmitting an eleventh message to a seventh node, wherein the eleventh message comprises the configuration information of QoE. In a further embodiment, the seventh node may be a secondary base station, a secondary node, or a centralized unit of the secondary base station/secondary node, or control plane part of the centralized unit of the secondary base station/secondary node, or a source secondary base station/secondary node, or a target secondary base station/secondary node.

In a further embodiment, the ninth message comprises at least one of the following: a message for requesting to add a second node; a message for requiring to modify the second node; a message for requesting to modify the second node; and a message for indicating completion of reconfiguration by the second node; a message for acknowledging/confirming a request of modifying the second node; and a message for acknowledging/confirming a request of releasing the second node; a message for requiring to change the second node; and a message for requiring to release the second node.

In a further embodiment, the configuration information of QoE comprises at least one of the following information: a QoE reference(s) or QoE reference ID(s); an application layer configuration ID(s); a measurement collection entity IP address(es); a measurement collection entity ID(s); a service type; a measurement status(es) of QoE; a configuration container(s) of QoE; Minimization of Drive Tests Alignment information; an area scope; a list of slice(s); and available QoE parameter(s)/metric(s) visible to radio access network.

In the above embodiments, the first node may be a master base station/master node, or a centralized unit of the master base station/master node, or control plane part of the centralized unit of the master base station/master node, or a source master base station/master node, or a target master base station/master node; and the second node may be a secondary base station, a secondary node, or a centralized unit of the secondary base station/secondary node, or control plane part of the centralized unit of the secondary base station/secondary node, or a source secondary base station/secondary node, or a target secondary base station/secondary node. Alternatively, the first node may be a secondary base station, a secondary node, or a centralized unit of the secondary base station/secondary node, or control plane part of the centralized unit of the secondary base station/secondary node, or a source secondary base station/secondary node, or a target secondary base station/secondary node; and the second node may be a master base station/master node, or a centralized unit of the master base station/master node, or control plane part of the centralized unit of the master base station/master node, or a source master base station/master node, or a target master base station/master node.

According to another aspect of the present disclosure, there is provided a first node in a wireless communication system, which comprises: a transceiver configured to transmit and receive a signal; and a controller coupled to the transceiver and configured to perform the operations in the methods as described above.

In the above embodiment, the first node is a master base station/master node, or a centralized unit of the master base station/master node, or control plane part of the centralized unit of the master base station/master node, or a source master base station/master node, or a target master base station/master node.

According to another aspect of the present disclosure, there is provided a second node in a wireless communication system, which comprises: a transceiver configured to transmit and receive a signal; and a controller coupled to the transceiver and configured to perform the operations in the methods as described above.

In the above embodiment, the second node is a secondary base station, a secondary node, or a centralized unit of the secondary base station/secondary node, or control plane part of the centralized unit of the secondary base station/secondary node, or a source secondary base station/secondary node, or a target secondary base station/secondary node.

According to another aspect of the present disclosure, there is provided a third node in a wireless communication system, which comprises: a transceiver configured to transmit and receive a signal; and a controller coupled to the transceiver and configured to perform the operations in the methods as described above.

In a further embodiment, the third node is a terminal, or an access layer of the terminal.

### BRIEF DESCRIPTION OF DRAWINGS

FIG. 1 is a system architecture diagram of System Architecture Evolution (SAE).

FIG. 2a, FIG. 2b, and FIG. 2c are schematic diagrams of an architecture of 5G.

FIG. 3a illustrates a first example of interaction between a first node and a second node.

FIG. 3b illustrates a second example of interaction between a first node and a second node.

FIG. 3c illustrates a first example of interaction between a third node and a first/second node.

FIG. 4a illustrates a first example of interaction between a first node and a fourth node.

FIG. 4b illustrates a third example of interaction between a first node and a second node.

FIG. 4c illustrates a fourth example of interaction between a first node and a second node.

FIG. 4d illustrates a fifth example of interaction between a first node and a second node.

FIG. 4e illustrates a second example of interaction between a third node and a first/second node.

FIG. 5a and FIG. 5b illustrate an example of switching a reporting link/path of a signalling-based Quality of Experience (QoE) measurement(s).

FIG. 5c illustrates an example of switching a reporting link/path of a management-based QoE measurement(s).

FIG. 5d illustrates an example of configuration negotiation of a signalling-based QoE measurement(s), involving a core network (in which a master node determines a configuration for QoE measurement).

FIG. 5e illustrates a second example of configuration negotiation of a signalling-based QoE measurement(s), involving a core network (in which a secondary node determines a configuration for QoE measurement).

FIG. 5f illustrates a third example of configuration negotiation of a signalling-based QoE measurement(s), involving a core network (in which a secondary node determines a configuration for QoE measurement).

FIG. 5g and FIG. 5h illustrate a first example of configuration negotiation of a signalling-based QoE measurement(s), reported by a terminal (in which an application layer session starts before a configuration of QoE).

FIG. 5i and FIG. 5j illustrate a second example of configuration negotiation of a signalling-based QoE measurement(s), reported by a terminal (in which an application layer session starts after configuration of QoE).

FIG. 5k and FIG. 5l illustrate a second example of management-based QoE measurement configuration negotiation (in which a secondary node receives a configuration of QoE from an Operations, Administration and Maintenance (OAM)).

FIG. 6a and FIG. 6b illustrate an example of enhancement of information exchange (or interaction) between nodes.

FIG. 6c illustrates an example of interface interaction enhancement for ensuring continuity of a QoE measurement in a scenario where a secondary node is changed, triggered by a master node.

FIG. 6d illustrates an example of interface interaction enhancement for ensuring continuity of a QE measurement in a scenario where a secondary node change is triggered by the secondary node.

FIG. 6e illustrates an example of interface interaction enhancement for ensuring continuity of a QoE measurement in a scenario where a secondary node change is triggered by a master node during master node handover.

FIG. 6f illustrates an example of interface interaction enhancement for ensuring continuity of a QoE measurement in a scenario where a secondary node release is triggered by a master node.

FIG. 6g illustrates an example of interface interaction enhancement for ensuring continuity of a QoE measurement in a scenario where a secondary node is released, triggered by a master node.

FIG. 7 illustrates an example of a block diagram of a network node according to an embodiment of the disclosure.

### MODE FOR THE INVENTION

In order to make the objectives, solutions and advantages of the embodiments of the present disclosure more clear, the solutions of the embodiments of the present disclosure will be clearly and completely described below with reference to the accompanying drawings of the embodiments of the present disclosure. Obviously, the described embodiments are some, but not all, of the embodiments of the present disclosure. Based on the described embodiments of the present disclosure, all other embodiments obtained by persons skilled in the art without creative efforts shall fall within the scope of the present disclosure.

Before undertaking the detailed description below, it may be advantageous to set forth definitions of certain words and phrases used throughout this patent document. The term “couple” and its derivatives mean any direct or indirect communication between two or more elements, whether or not those elements are in physical contact with each other. The terms “transmit”, “receive” and “communicate” and their derivatives encompass both direct and indirect communications. The terms “include” and “comprise,” as well as derivatives thereof, mean inclusion without limitation. The term “or,” is inclusive, meaning and/or. The phrase “associated with” and derivatives thereof, mean to comprise, be included within, interconnect with, contain, be contained within, connect to or with, couple to or with, be communicable with, cooperate with, interleave, juxtapose, be proximate to, be bound to or with, have, have a property of, or the like. The term “controller” means any device, system or part thereof that controls at least one operation. Such a device may be implemented in hardware, firmware or software, or some combination of at least two of the same. The functionality associated with any particular controller may be centralized or distributed, whether locally or remotely. The phrase “at least one of” when used with a list of items means that different combinations of one or more of the listed items may be used, and that only one item of the list may be required. For example, “at least one of A, B, and C” comprises any of the following combinations: A, B, C, A and B, A and C, B and C, and A and B and C. For example, “at least one of A, B, or c” comprises any of the following combinations: A, B, C, A and B, A and C, B and C, and A, and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” comprises any type of computer code, including source code, object code, and executable code. The phrase “computer readable medium” comprises any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links/paths that transport transitory electrical or other signals. A non-transitory computer readable medium comprises media where data can be permanently stored and media where data can be stored and later overwritten, such as a rewritable optical disc or an erasable memory device.

The terminology used herein to describe embodiments of the invention is not intended to limit and/or define the scope of the invention. For example, unless otherwise defined, technical or scientific terms used in this disclosure should be given the ordinary meaning as understood by one of ordinary skill in the art to which this invention belongs.

It should be understood that use of “first,” “second,” and similar terms in this disclosure do not denote any order, quantity, or importance, but are merely used to distinguish the various components. Unless the context clearly dictates otherwise, the singular forms “a,” “an,” or “the” and similar words do not denote a limitation of quantity, but rather denote the presence of at least one.

As used herein, any reference to “one example” or “example”, “one embodiment” or “an embodiment” means that a particular element, feature, structure or characteristic described in connection with the embodiment is included in at least one in the examples. The appearances of the phrases “in one embodiment” or “in one example” in various places in the specification are not necessarily all referring to the same embodiment.

As used herein, “a portion” of something means “at least some” of that thing, and thus may mean less than all or all of that thing. Thus, “a part” of a thing comprises the whole thing as a special case, i.e., instances where the whole thing is a part of the thing.

It will be further understood that the terms “comprise” or “include” and similar words mean that the elements or things appearing before the word encompass the elements or things listed after the word and their equivalents, but do not exclude other elements or things. Words like “connected” or “connected” are not limited to physical or mechanical connections, but may comprise electrical connections, whether direct or indirect. “Up”, “Down”, “Left”, “Right”, etc. are only used to represent the relative positional relationship, and when the absolute position of the described object changes, the relative positional relationship may also change accordingly.

The various embodiments discussed below to describe the principles of the present disclosure in this patent document are by way of illustration only and should not be construed in any way to limit the scope of the disclosure. Those skilled in the art will understand that the principles of the present disclosure may be implemented in any suitably arranged wireless communication system. For example, although the following detailed description of embodiments of the present disclosure will be directed to LTE and 5G communication systems, those skilled in the art will appreciate that the main points of the present disclosure may be modified slightly without substantially departing from the scope of the present disclosure. It can be applied to other communication systems with similar technical background and channel format. The solutions of the embodiments of the present application may be applied to various communication systems. For example, the communication systems may comprise a Global System for Mobile communications (GSM) system, a code division multiple access (CDMA) system, a broadband Code Division Multiple Access (WCDMA) system, General Packet Radio Service (GPRS), Long Term Evolution (LTE) system, LTE Frequency Division Duplex (FDD) system, LTE Time Division Duplex (TDD), universal mobile telecommunication system (UMTS), worldwide interoperability for microwave access (WiMAX) communication system, fifth generation (5th generation, 5G) system or new radio (NR), etc. In addition, the solutions of the embodiments of the present application may be applied to future-oriented communication technology. In addition, the solutions of the embodiments of the present application may be applied to future-oriented communication technology.

The following description with reference to the accompanying drawings is provided to facilitate a comprehensive understanding of various embodiments of the present disclosure as defined by the claims and their equivalents. This description comprises various specific details to facilitate understanding but should be regarded as exemplary only. Accordingly, those of ordinary skill in the art will recognize that various changes and modifications of the various embodiments described herein can be made without departing from the scope of the present disclosure. Also, descriptions of well-known functions and constructions may be omitted for clarity and conciseness.

The terms and phraseology used in the following specification and claims are not limited to their dictionary meanings, but, are merely used by the inventor to enable a clear and consistent understanding of the present disclosure. Accordingly, it should be apparent to those skilled in the art that the following description of various embodiments of the present disclosure is provided for illustration purposes only and not for the purpose of limiting the scope of the present disclosure as defined by the appended claims and their equivalents.

It should be understood that the singular forms “a”, “an” and “the” include plural referents unless the context clearly dictates otherwise. Thus, for example, reference to “a component surface” comprises reference to one or more of such surfaces.

The terms “comprise” or “may comprise” refer to presence of a correspondingly disclosed function, operation, or component that may be used in various embodiments of the present disclosure, rather than excluding presence of one or more additional functions, operations, or features. Furthermore, the terms “comprise” or “have” may be interpreted to mean certain characteristics, numbers, steps, operations, constituent elements, components, or combinations thereof, but should not be interpreted as excluding one or more other characteristics, numbers, steps, operations, constituent elements, components, or the possibility of existence of a combination thereof.

The term “or” as used in various embodiments of the present disclosure comprises any of the listed terms and all combinations thereof. For example, “A or B” may comprise A, may comprise B, or may comprise both A and B.

Unless defined differently, all terms (comprising technical or scientific terms) used in this disclosure have the same meaning as understood by one of ordinary skill in the art described in this disclosure. Common terms as defined in dictionaries are to be interpreted to have meanings consistent with the context in the relevant technical field, and should not be interpreted ideally or overly formalized unless explicitly so defined in this disclosure.

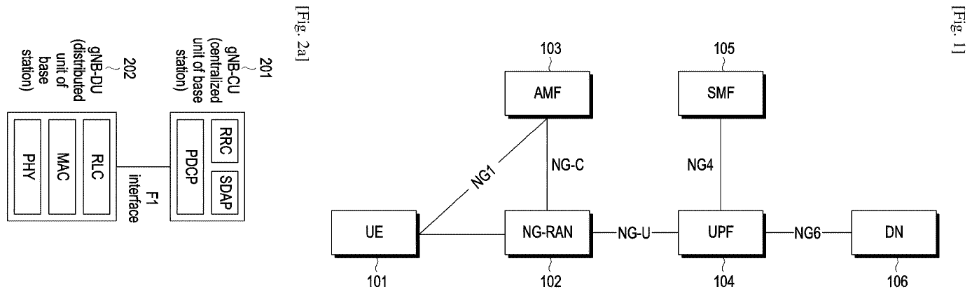

FIGS. 1 through 5l, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

FIG. 1 is an exemplary system architecture 200 according to various embodiments of the present disclosure. Other embodiments of the system architecture 200 may be used without departing from the scope of this disclosure.

Referring to FIG. 1, an user equipment (UE) 101 may be a terminal device for receiving data. An next generation radio access network (NG-RAN) 102 may be a radio access network that comprises base stations (e.g., gNBs or eNBs connected to the 5G core network 5GC, also called ng-gNBs) that provide UEs with access to the radio network interface. An access control and mobility management function (AMF) 103 may be responsible for managing a mobility context and security information of the UE. An user plane function (UPF) 104 may mainly provide functions of a user plane. An session management function (SMF) 105 may be responsible for session management. An data network (DN) 106 may comprise services by an operator, access to Internet, and third-party services and the like.

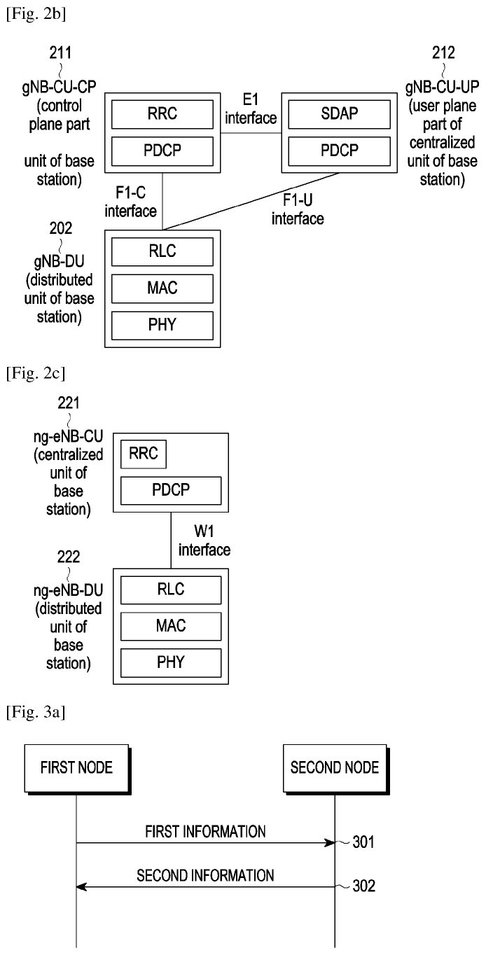

In a NR system, in order to support network function virtualization, more efficient resource management and scheduling, the base station (gNB/ng-eNB) providing the radio network interface for a terminal (UE) may be further divided into a centralized unit gNB-CU 201 and/or ng-eNB-CU 221 (e.g., gNB central unit and/or ng-eNB central unit) and a distributed unit gNB-DU 202 and/or ng-eNB-DU 222 (gNB distributed unit/ng-eNB distributed unit) (referred to as CU and DU for short in this invention), as illustrated in FIG. 2a.

Referring to FIG. 2a, gNB-CU 201 may comprise a Radio Resource Control (RRC) layer, Service Data Adaptation Protocol (SDAP) and Packet Data Convergence Protocol (PDCP) protocol layer, etc. and ng-eNB-CU 221 has a RRC and PDCP layer. gNB-DU 202/ng-eNB-DU 222 may comprise a Radio Link Control protocol (RLC), Medium Access Control (MAC) and physical layer, etc. Between gNB-CU 201 and gNB-DU 202 is a standardized public interface F1, and between ng-eNB-CU 221 and ng-eNB-DU 222 is a standardized public interface W1. The F1 interface is divided into a control plane F1-C and a user plane F1-U. The transport network layer of F1-C is transmitted based on IP. In order to transmit signalling more reliably, a SCTP protocol is added over IP. The protocol of the application layer is F1AP, see 3GPP TS38.473 .

SCTP may provide reliable application layer message transmission. The transport layer of F1-U is UDP/IP, and GTP-U is used to carry user plane protocol data unit PDU over UDP/IP. Furthermore, for gNB-CU 201, as illustrated in FIG. 2b, Referring to FIG. 2b, gNB-CU 201 may comprise gNB-CU-CP 211 (control plane part of centralized unit of base station) and gNB-CU-UP 212 (user plane part of centralized unit of base station). gNB-CU-CP 211 may comprise functions of the control plane of the base station, with RRC and PDCP protocol layers, and gNB-CU-UP 212 may comprise functions of the user plane of the base station, with SDAP and PDCP protocol layers. Between gNB-CU-CP 211 and gNB-CU-UP 212 is a standardized public interface E1, and the protocol is E1AP, see 3GPP TS38.463 . The interface between the control plane part of the centralized unit of the base station and the distributed unit of the base station is the F1-C interface, that is, the control plane interface of F1, and the interface between the user plane part of the centralized unit of the base station and the distributed unit of the base station is the F1-U interface, that is, the user interface of F1.

In addition, in the NR system, the base station that provides the E-UTRA user plane and control plane accessing the 5G core network is referred to as ng-eNB. In order to support virtualization, this base station (e.g., ng-eNB) may also be further divided into a centralized unit ng-eNB-CU 221 (e.g., gNB central unit and/or ng-eNB central unit) and a distributed unit ng-eNB-DU 222 (e.g., gNB distributed unit and/or ng-eNB distributed unit) (referred to as CU and DU for short in the present disclosure), as illustrated in FIG. 2c.

Referring FIG. 2c, the ng-eNB-CU 221 may comprise a RRC and a PDCP layer. The gNB-DU 202/ng-eNB-DU 222 may comprise a Radio Link Control protocol (RLC), a Medium Access Control (MAC), a physical layer, etc. Between the ng-eNB-CU 221 and the ng-eNB-DU 222 is a standardized public interface W1. The W1 interface is divided into control plane W1-C and user plane W1-U. The transport network layer of W1-C is transmitted based on IP. In order to transmit signalling more reliably, SCTP protocol is added over IP. The protocol of the application layer is W1AP, see GPP TS37.473. The transport layer of W1-U is UDP/IP, and GTP-U is used to carry user plane Protocol Data Unit (PDU) over UDP/IP.

At present, for QoE (Quality of Experience) research is mainly made on the QoE measurement that supports single connectivity, and no research is made on the measurement that supports dual-connectivity or multi-connectivity. Embodiments of the present disclosure mainly relates to measurement enhancement that supports dual-connectivity or multi-connectivity. It should be noted that the following embodiments only take dual-connectivity as an example, but are also applicable to multi-connectivity.

Exemplary embodiments of the present disclosure are further described below in con-junction with the accompanying drawings.

The text and figures are provided by way of example only to aid in understanding of the present disclosure. They should not be construed to limit the scope of the present disclosure in any way. While certain embodiments and examples have been provided, based on the disclosure herein, it will be apparent to those skilled in the art that the illustrated embodiments and examples may be varied without departing from the scope of the present disclosure.

Before introducing the specific content, some assumptions and some definitions of the present disclosure are given below.
The message names in the present disclosure are just examples, and other message names may also be used.
The “first”, “second”, etc. contained in the message names of the present disclosure are just examples of messages, and do not represent the execution order.
In the present disclosure, detailed descriptions of steps unrelated to the present disclosure are omitted.
In the present disclosure, the steps in each procedure may be executed in combination with each other, or may be executed individually. The execution steps of each procedure are only examples, and other possible execution orders are not excluded.
In the present disclosure, a base station may be a 5G base station (such as gNB, ng-eNB), a 4G base station (such as an eNB), a 6G base station, or other types of access nodes.
In the present disclosure, transmission of data refers to receiving or sending of the data.

Following nodes are involved in embodiments of FIG. 1 to FIG. 7 of the present disclosure:
First node: master base station (or referred to as master node), or centralized unit of master base station/master node, or control plane part of centralized unit of master base station/master node, or source master base station/master node, or target master base station/master node
Second node: secondary base station (or referred to as secondary node), or centralized unit of secondary base station/secondary node, or control plane part of centralized unit of secondary base station/secondary node, or source secondary base station/secondary node, or target secondary base station/secondary node
Third node: terminal, or access layer of terminal
Fourth node: core network
Fifth node: network operation management and maintenance entity
Sixth node: measurement collection entity

Solution of the present disclosure:
measurement of quality of experience (QoE) supporting dual-connectivity or multi-connectivity is enhanced by means of information exchange between nodes.

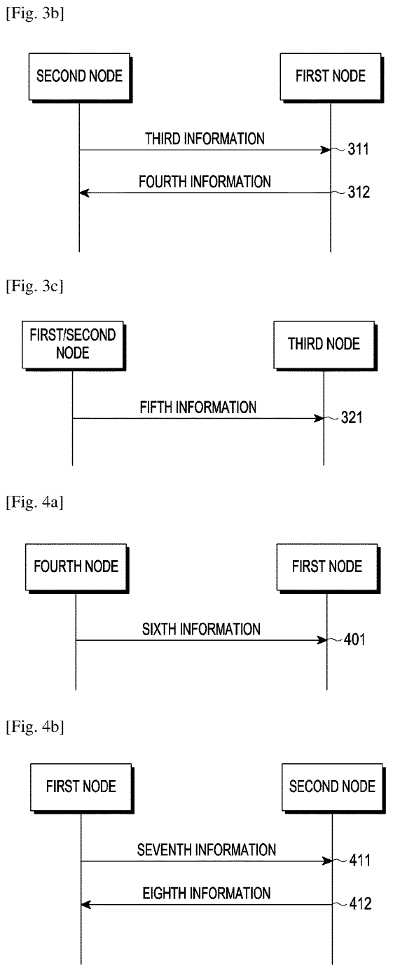

As illustrated in FIG. 3a, in step 311, a first node may transmit first information to a second node, wherein the first information may comprise at least one of the following information:
a first indication message;
a Quality of Experience (QoE) Reference or QoE Reference ID;
an application layer configuration ID;
a measurement Collection entity IP address;
a measurement collection entity ID; or
a switching direction of a reporting link/path.

Wherein the first indication information may comprise at least one of the following information:
information indicating a QoE measurement or report is reported by a master node or a secondary node;
information indicating the QoE measurement or report is reported by the master node;
information indicating the QoE measurement or report is reported by the secondary node; or
information indicating the reporting link/path of the QoE measurement or report is requested/required to be switched.

The first information may be included in the existing XnAP S-NODE ADDITION REQUEST (Xn Application Protocol (XnAP) Secondary Node Addition Request) message, or may be included in the existing XnAP S-NODE MODIFICATION REQUEST (XnAP Secondary Node Modification Request) message, and may also be included in other existing XnAP messages or new XnAP messages.

In step 302, after receiving the first information, the second node may determine to switch the reporting link/path according to the content of the first information, and transmit second information to the first node, wherein the second information may comprise at least first acknowledgement information, wherein the first acknowledgement information may comprise at least one of the following information:
information of acknowledging/confirming the QoE measurement or report is reported by the master node or the secondary node;
information of acknowledging/confirming the QoE measurement or report is reported by the master node;
information of acknowledging/confirming the QoE measurement or report is reported by the secondary node; or
information of acknowledging/confirming switching of the reporting link/path of the QoE measurement or report.

The second information may be included in the existing XnAP S-NODE ADDITION REQUEST ACKNOWLEDGE (XnAP Secondary Node Addition Request Acknowledgment) message, in the existing XnAP S-NODE MODIFICATION REQUEST ACKNOWLEDGE (XnAP Secondary Node Modification Request Acknowledgment) message, or in other existing XnAP messages or new XnAP messages.

In this embodiment, the first node transmits the first message to the second node, the first message comprising the first indication information related to the reporting link/path of the QoE report, and then receives the response message from the second node in response to the first message, so as to ensure flexible switch of the reporting link/path in the scenarios of dual-connectivity or multi-connectivity. By means of such information exchange between nodes, it is possible to enhance the measurement of the QoE supporting dual-connectivity or multi-connectivity.

As illustrated in FIG. 3b, in step 311, the second node may transmit third information to the first node, wherein the third information may comprise at least one of the following information:
seventh indication message;
a Quality of Experience (QoE) Reference or QoE Reference ID;
an application layer configuration ID;
a measurement collection entity IP address;
a measurement collection entity ID; or
a switching direction of a reporting link/path.

Wherein the seventh indication information may comprise at least one of the following information:
information indicating a QoE measurement or report is reported by a master node or a secondary node;
information indicating the QoE measurement or report is reported by the master node;
information indicating the QoE measurement or report is reported by the secondary node; or
information indicating the reporting link/path of the QoE measurement or report is requested/required to be switched.

The third information may be included in the existing XnAP S-NODE MODIFICATION REQUIRED (XnAP Secondary Node Modification Required) message, or in other existing XnAP messages or new XnAP messages.

In step 312, after receiving the third information, the first node may determine to switch the reporting link/path according to the content of the third information, and transmit fourth information to the second node, wherein the fourth information may comprise at least second acknowledgement information, and wherein the second acknowledgement information may comprise at least one of the following information:
information of acknowledging/confirming the QoE measurement or report is reported by the master node or the secondary node;
information of acknowledging/confirming the QoE measurement or report is reported by the master node;
information of acknowledging/confirming the QoE report or measurement is reported by the secondary node; or
information of acknowledging/confirming switching of the reporting link/path of the QoE measurement or report.

The fourth information may be included in the existing XnAP S-NODE MODIFICATION CONFIRM (XnAP Secondary Node Modification Confirm) message, or in other existing XnAP messages or new XnAP messages.

In this embodiment, the first node receives a fifth message from the second node, the fifth message comprising third information, and the third information comprising seventh indication information related to measurement of QoE, and then transmits a second response message to the second node in response to the fifth message, so as to ensure flexible switch of the reporting link/path in a dual-connectivity or multi-connectivity scenario. By means of information exchange between nodes, it is possible to enhance the measurement of QoE supporting dual-connectivity or multi-connectivity.

As illustrated in FIG. 3c, in step 321, a first or second node may transmit fifth information to a third node, where the fifth information may comprise at least one of the following information:
eighth indication information; or
node information.

Wherein the eighth indication information comprises at least one of the following information:
information indicating the QoE measurement or report is reported by a master node or a secondary node
information indicating the QoE measurement or report is reported by the master node
information indicating the QoE measurement or report is reported by the secondary node
information indicating switching of the reporting link/path of the QoE measurement or report

The node information is used to indicate a reporting node to which a terminal is requested/required to be switched.

The fifth information may be included in the existing RRC Reconfiguration message, or in other existing RRC messages or new RRC messages.

The third node may perform RRC reconfiguration based on the fifth information.

By means of information exchange between nodes, the measurement of QoE supporting dual-connectivity or multi-connectivity may be further enhanced.

In order to ensure reporting of the measurement configuration of QoE that supports dual-connectivity, this disclosure provides a measurement configuration negotiation method that supports dual-connectivity, which ensures proper configuration of QoE measurement on the air interface in the dual-connectivity scenario by mean of enhancing information exchange between nodes. In addition, issues such as the suitable nodes cannot be involved in the measurement configuration may also be solved with this method.

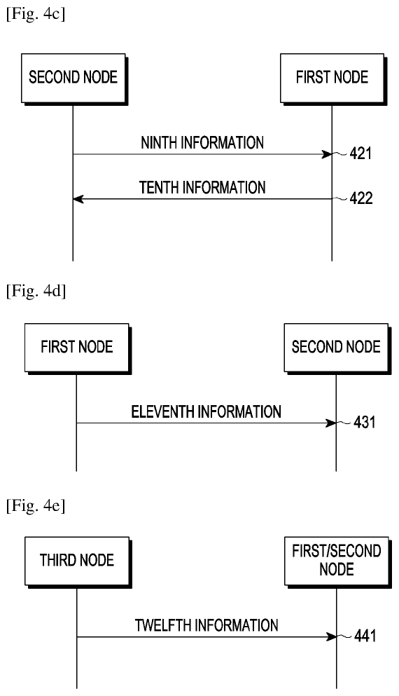

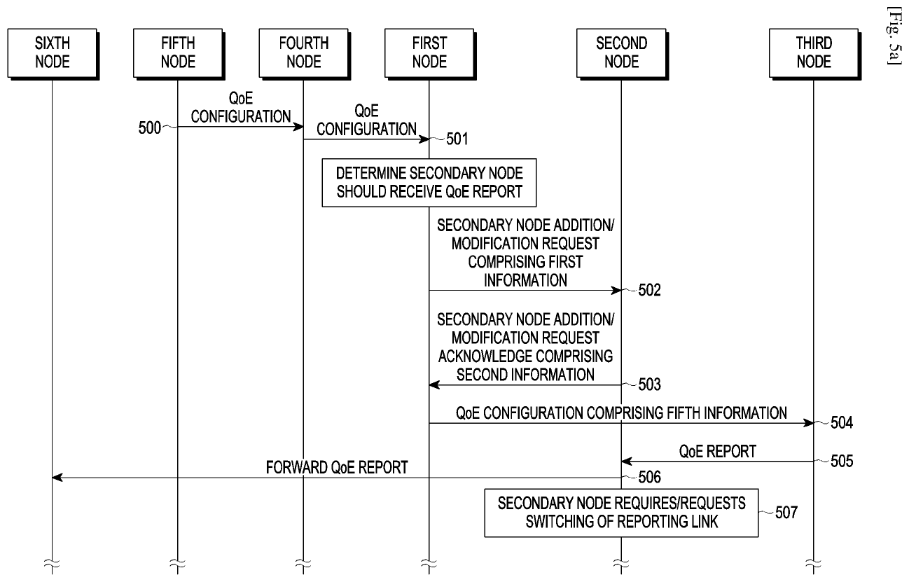

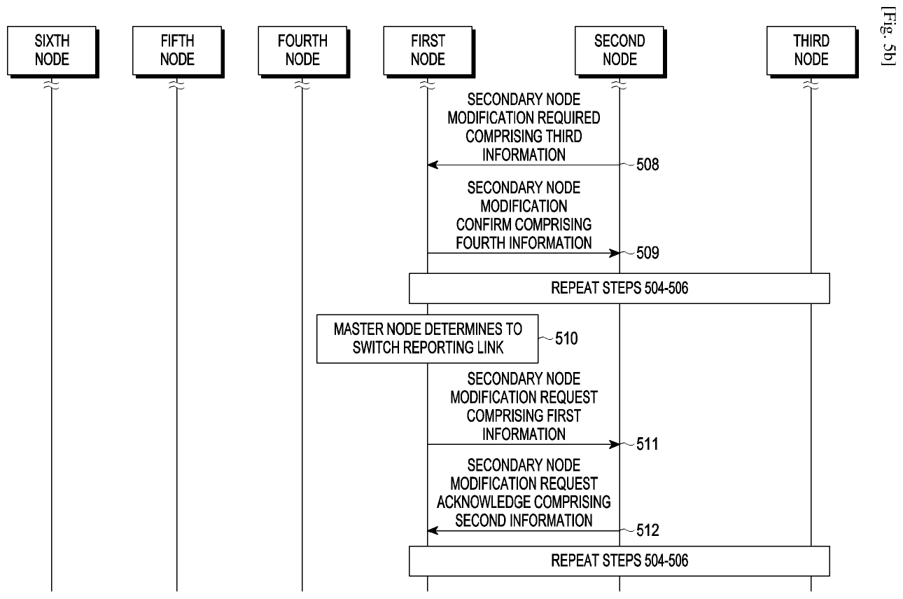

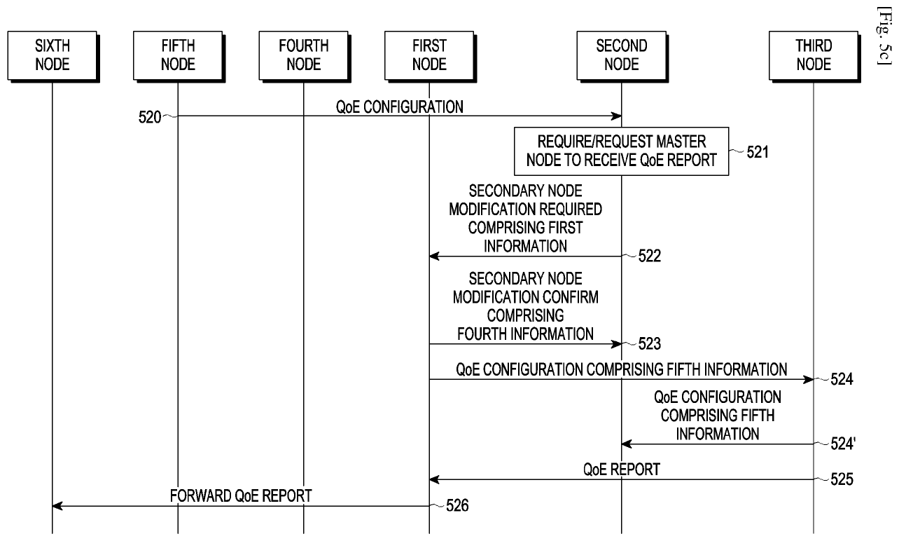

As illustrated in FIG. 4a, in step 401, a fourth node may transmit sixth information to a first node, wherein the sixth information may comprise at least application layer related information, and wherein the application layer related information may comprise at least one of the following information:
first association/mapping information, which is used to associate/map an application layer or an application layer session with a Protocol Data Unit (PDU) session and/or QoS flow ID (QFI).

Wherein the first association/mapping information may comprise at least one of the following information:
a PDU session ID;
a PDU session list, which comprises at least one PDU session ID;
a QoS flow ID; or
a QoS flow ID list, which comprises at least one QoS flow ID.

The sixth information may be included in the existing NGAP INITIAL CONTEXT SETUP REQUEST message, or may be included in the existing NGAP UE CONTEXT MODIFICATION REQUEST message, or may be included in other existing NGAP messages or new NGAP messages.

By means of such enhanced information exchange between nodes, proper configuration of QoE measurement on the air interface in the dual-connectivity scenario may be ensured. In addition, issues such as the suitable nodes cannot be involved in the measurement configuration may also be solved with this method.

As illustrated in FIG. 4B, in step 411, a first node may transmit seventh information to a second node, wherein the seventh information may comprise at least one of the following information:
configuration related parameters/metrics of Quality of Experience (QoE) or configuration related parameters/metrics of QoE visible to radio access network;
recommended/suggested configuration related parameters/metrics of QoE or recommended/suggested configuration related parameters/metrics of QoE visible to radio access network;
first request information;
first association/mapping information;
PDU session related indication information;
third indication information;
Quality of Experience (QoE) Reference or a QoE Reference ID;
a service type; or
fourth indication information.

The configuration related parameters/metrics of QoE or configuration related parameters/metrics of QoE visible to the radio access network, or the recommended/suggested configuration related parameters/metrics of QoE or recommended/suggested configuration related parameters/metrics of QoE visible to the radio access network includes but is not limited to at least one of the following information:
a radio access network visible periodicity, which is used to provide a reporting period of a QE measurement visible to radio access network;
a buffer level indication, which is used to indicate that buffer level related parameter(s)/metric(s) are provided in the configuration, or that the buffer level related parameter(s)/metric(s) are configurable;
number of buffer level entries;
an indication of a playout delay for media startup, which is used to indicate parameter(s)/metric(s) related to the playout delay for media startup are provided in the configuration, or the parameter(s)/metric(s) related to the playout delay for media startup are configurable; or
an indication of reporting the playout delay for media startup, which is used to indicate whether to report the playout delay for media startup.

Wherein the first request information is used to request the configuration related parameters/metrics of QoE or configuration related parameters/metrics of QoE visible to the radio access network.

Wherein the first association/mapping information comprises at least one of the following information:
a PDU session ID;
a PDU session list, comprising at least one PDU session ID;
a QoS flow ID; or
a QoS flow ID list, comprising at least one QoS flow ID.

Wherein the PDU session related indication information comprises at least one of the following information:
a PDU session ID;
a PDU session list, comprising at least one PDU session ID; or
a second indication information.

Wherein the second indication information is used to indicate that a PDU session corresponding to a PDU session ID or a PDU session list is at a master node or a secondary node.

Wherein the third indication information is used to indicate a master node has received or has not received a new or same management-based configuration of QoE.

Wherein the fourth indication information is used to indicate a configuration of QoE or a configuration of QoE visible to radio access network is provided by a master node or secondary node.

The seventh information may be included in the existing XnAP S-NODE ADDITION REQUEST message, in the existing XnAP S-NODE MODIFICATION REQUEST message, or in other existing XnAP messages or new XnAP messages.

In step 412, after receiving the seventh information, the second node may acknowledge/confirm or provides a configuration of QoE or a configuration of QoE visible to the radio access network according to the content of the seventh information, and transmit eighth information to the first node, wherein the eighth information may comprise at least one of the following messages:
information of acknowledging/confirming the configuration of QoE or the configuration of QoE visible to the radio access network;
configuration related parameters/metrics of QoE or configuration related parameters/metrics of QoE visible to the radio access network; or
recommended/suggested configuration related parameters/metrics of QoE or recommended/suggested configuration related parameters/metrics of QoE visible to the radio access network.

Wherein the configuration related parameters/metrics of QoE or configuration related parameters/metrics of QoE visible to the radio access network, or the recommended/suggested configuration related parameters/metrics of QoE or recommended/suggested configuration related parameters/metrics of QoE visible to the radio access network includes but is not limited to at least one of the following information:
a radio access network visible periodicity, which is used to provide a reporting period of a QoE measurement visible to radio access network;
a buffer level indication, which is used to indicate that buffer level related parameter(s)/metric(s) are provided in the configuration, or that the buffer level related parameter(s)/metric(s) are configurable;
number of buffer level entries;
an indication of a playout delay for media startup, which is used to indicate parameter(s)/metric(s) related to the playout delay for media startup are provided in the configuration, or the parameter(s)/metric(s) related to the playout delay for media startup are configurable; or
an indication of reporting the playout delay for media startup, which is used to indicate whether to report the playout delay for media startup.

The eighth information may be included in the existing XnAP S-NODE ADDITION REQUEST ACKNOWLEDGE message, in the existing XnAP S-NODE MODIFICATION REQUEST ACKNOWLEDGE message, or in other existing XnAP messages or new XnAP messages.

In this embodiment, the first node transmits the second message to the second node, the second message comprising the seventh information, wherein the seventh information comprises at least one of the following: configuration information of QoE related parameters/metrics visible to radio access network and recommended/suggested configuration information of QoE related parameters/metrics visible to the radio access network; and then receive the third response message from the second node in response to the second message, so as to ensure proper configuration of QoE measurement on the air interface in the dual-connectivity or multi-connectivity scenario.

By means of such enhanced information exchange between nodes, proper configuration of QoE measurement on the air interface in the dual-connectivity scenario may be ensured. In addition, issues such as the suitable nodes cannot be involved in the measurement configuration may also be solved with this method.

As illustrated in FIG. 4C, in step 421, a second node may transmit ninth information to a first node, wherein the ninth information may comprise at least one of the following information:
configuration related parameters/metrics of Quality of Experience (QoE) or configuration related parameters/metrics of QoE visible to radio access network;
recommended/suggested configuration related parameters/metrics of QoE or recommended/suggested configuration related parameters/metrics of QoE visible to the radio access network;
second request information;
PDU session related indication information;
fifth indication information;
QoE Reference or QoE Reference ID; or
a service type.

Wherein the configuration related parameters/metrics of QoE or configuration related parameters/metrics of QoE visible to the radio access network, or the recommended/suggested configuration related parameters/metrics of QoE or recommended/suggested configuration related parameters/metrics of QoE visible to the radio access network includes but is not limited to at least one of the following information:
a radio access network visible periodicity, which is used to provide a reporting period of a QoE measurement visible to radio access network;
a buffer level indication, which is used to indicate that buffer level related parameter(s)/metric(s) are provided in the configuration, or that the buffer level related parameter(s)/metric(s) are configurable;
number of buffer level entries;
an indication of a playout delay for media startup, which is used to indicate parameter(s)/metric(s) related to the playout delay for media startup are provided in the configuration, or the parameter(s)/metric(s) related to the playout delay for media startup is configurable; or
an indication of reporting the playout delay for media startup, which is used to indicate whether to report the playout delay for media startup. Wherein the second request information is used to request the configuration related parameters/metrics of QoE or configuration related parameters/metrics of QoE visible to the radio access network,

Wherein the PDU session related indication information comprises at least one of the following information:
a PDU session ID;
a PDU session list, comprising at least one PDU session ID; or
ninth indication information.

Wherein the ninth indication information is used to indicate that a PDU session corresponding to a PDU session ID or a PDU session list is at a master node or a secondary node.

Wherein the fifth indication information is used to indicate a secondary node has received a new or same management-based configuration of QoE.

The ninth information may be included in the existing XnAP S-NODE MODIFICATION REQUIRED message, or in other existing XnAP messages or new XnAP messages.

In step 422, after receiving the ninth information, the first node may acknowledge/confirm or provides a configuration of QoE or a configuration of QoE visible to the radio access network according to the content of the ninth information, and transmit tenth information to the second node, wherein the tenth information comprises at least the following One of the messages:
acknowledgement of the configuration of QoE or the configuration of QoE visible to the radio access network;
configuration related parameters/metrics of QoE or configuration related parameters/metrics of QoE visible to the radio access network;
tenth indication information; or
eleventh indication information.

Wherein the configuration related parameters/metrics of QoE or configuration related parameters/metrics of QoE visible to the radio access network includes but is not limited to at least one of the following information:
a radio access network visible periodicity, which is used to provide a reporting period of a QoE measurement visible to radio access network;
a buffer level indication, which is used to indicate that buffer level related parameter(s)/metric(s) are provided in the configuration, or that the buffer level related parameter(s)/metric(s) are configurable;
number of buffer level entries;
an indication of a playout delay for media startup, which is used to indicate parameter(s)/metric(s) related to the playout delay for media startup is provided in the configuration, or the parameter(s)/metric(s) related to the playout delay for media startup are configurable; or
an indication of reporting the playout delay for media startup, which is used to indicate whether to report the playout delay for media startup.

Wherein the tenth indication information is used to indicate a master node has received or not received a new or same management-based configuration of QoE.

Wherein the eleventh indication information is used to indicate a configuration of QoE or a configuration of QoE visible to radio access network is provided by a master node or secondary node.

The tenth information may be included in the existing XnAP S-NODE MODIFICATION CONFIRM message, or in other existing XnAP messages or new XnAP messages.

In this embodiment, the first node receives a third message from the second node, the third message comprising ninth information, wherein the ninth information comprises at least one of the following: configuration information of QoE related parameters/metrics visible to radio access network and recommended/suggested configuration information of QoE related parameters/metrics visible to the radio access network; and then transmits a fourth response message in response to the third message to the second node, so as to ensure proper configuration of QoE measurement on the air interface in the dual-connectivity or multi-connectivity scenario.

By means of such enhanced information exchange between nodes, proper configuration of QoE measurement on the air interface in the dual-connectivity scenario may be ensured. In addition, issues such as the suitable nodes cannot be involved in the measurement configuration may also be solved with this method.

As illustrated in FIG. 4d, in step 431, a first node may transmit eleventh information to a second node, wherein the eleventh information may comprise at least one of the following information:
acknowledgement of a Quality of Experience (QoE) configuration or a configuration of QoE visible to radio access network; or
configuration related parameters/metrics of QoE or configuration related parameters/metrics of QoE visible to the radio access network.

Wherein the configuration related parameters/metrics of QoE or configuration related parameters/metrics of QoE visible to the radio access network comprise but is not limited to at least one of the following information:
a radio access network visible periodicity, which is used to provide a reporting period of a QoE measurement visible to radio access network;
a buffer level indication, which is used to indicate that buffer level related parameter(s)/metric(s) are provided in the configuration, or that the buffer level related parameter(s)/metric(s) are configurable;
number of buffer level entries;
an indication of a playout delay for media startup, which is used to indicate parameter(s)/metric(s) related to the playout delay for media startup is provided in the configuration, or the parameter(s)/metric(s) related to the playout delay for media startup are configurable; or
an indication of reporting the playout delay for media startup, which is used to indicate whether to report the playout delay for media startup.

The eleventh information may be included in the existing XnAP S-NODE RECONFIGURATION COMPLETE (XnAP Secondary Node Reconfiguration Complete) message, or in other existing XnAP messages or new XnAP messages.

By means of such enhanced information exchange between nodes, proper configuration of QoE measurement on the air interface in the dual-connectivity scenario may be ensured. In addition, issues such as the suitable nodes cannot be involved in the measurement configuration may also be solved with this method.

As illustrated in FIG. 4e, in step 441, a third node may transmit twelfth information to a first/second node, wherein the twelfth information may comprise at least one of the following information:
sixth indication information; or
PDU session and/or QoS related information.

Wherein the sixth indication information is used to indicate that there is new application layer session starting or ending.

Wherein the PDU session and/or QoS related information comprises at least one of the following information:
a PDU session ID;
a PDU session list, comprising at least one PDU session ID;
a QoS flow ID; or
a QoS flow ID list, comprising at least one QoS flow ID.

Furthermore, the PDU session and/or QoS related information may indicate PDU session and/or QoS information associated with all ongoing application layer sessions, or PDU session and/or QoS information associated with a newly started application layer session, or PDU session and/or QoS information associated with a newly ended application layer session. The twelfth information may be included in the existing RRC Reconfiguration message, or in other existing RRC messages or new RRC messages.

In this embodiment, the third node receives at least one of the following from a terminal application layer: at least one Protocol Data Unit (PDU) session and/or at least one Quality of Service (QoS) flow related information, and then transmits an eighth message to the first node or second node, wherein the eighth message comprises twelfth information related to the QoE report, wherein the twelfth information comprises at least one of the following: at least one Protocol Data Unit (PDU) session and/or at least one Quality of Service (QoS) flow related information, so as to ensure proper configuration of QoE measurement on the air interface in the dual-connectivity or multi-connectivity scenario.

By means of such enhanced information exchange between nodes, proper configuration of QoE measurement on the air interface in the dual-connectivity scenario may be ensured. In addition, issues such as the suitable nodes cannot be involved in the measurement configuration may also be solved with this method.

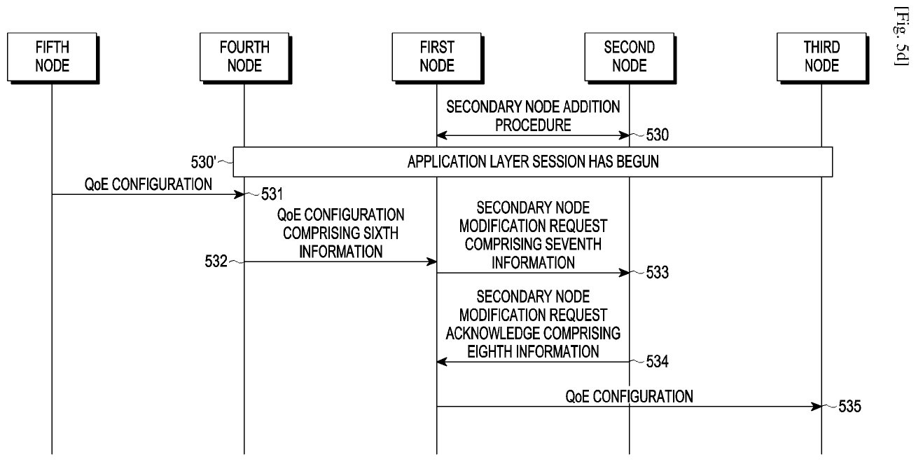

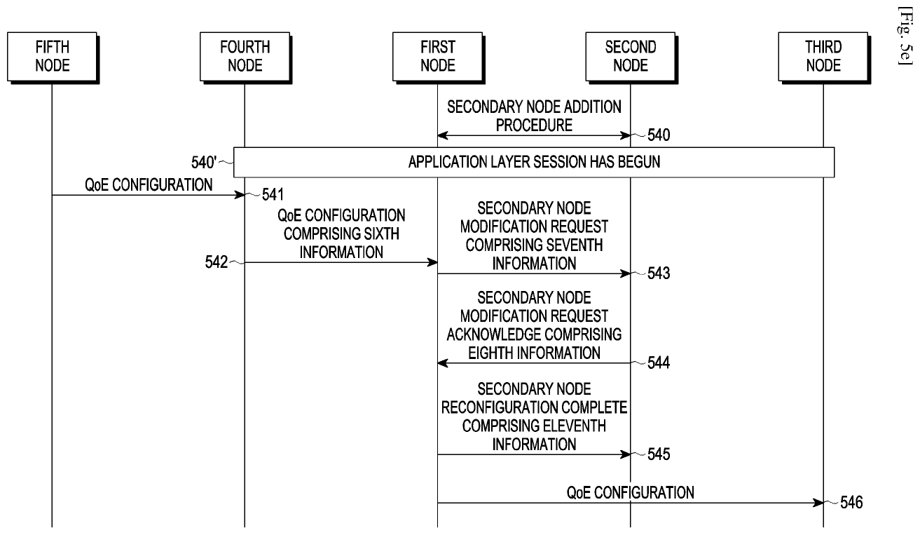

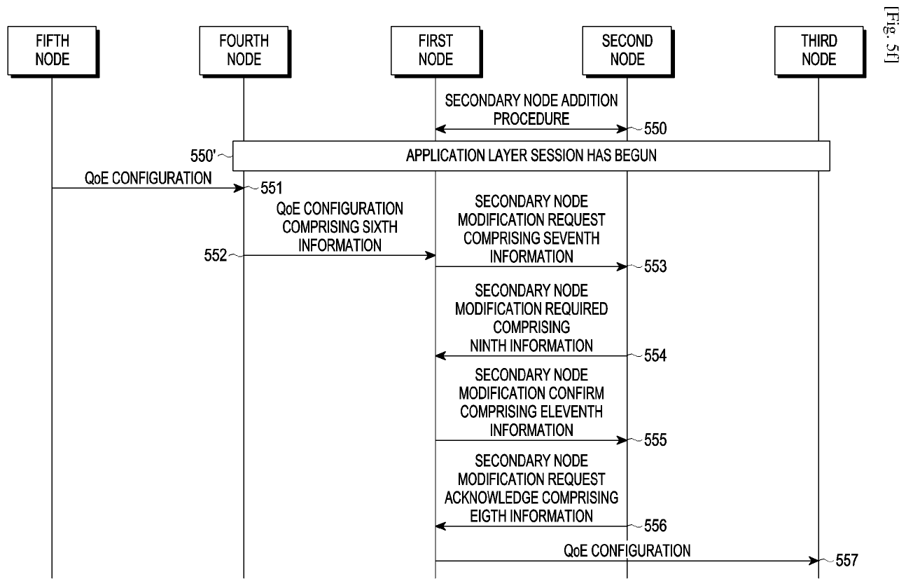

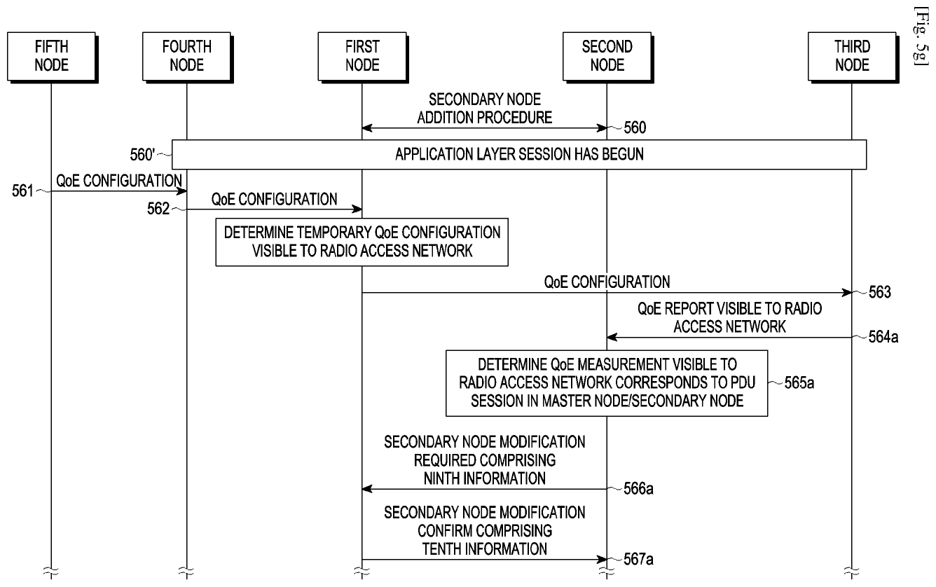

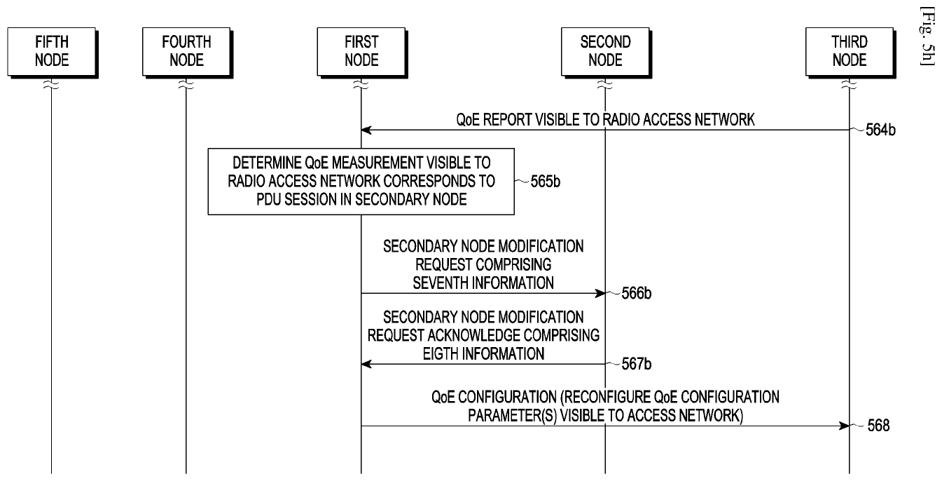

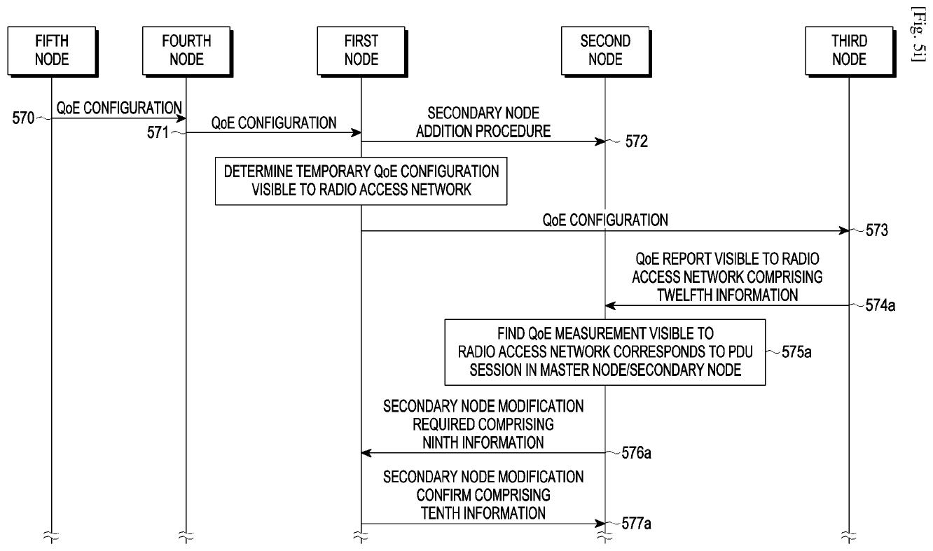

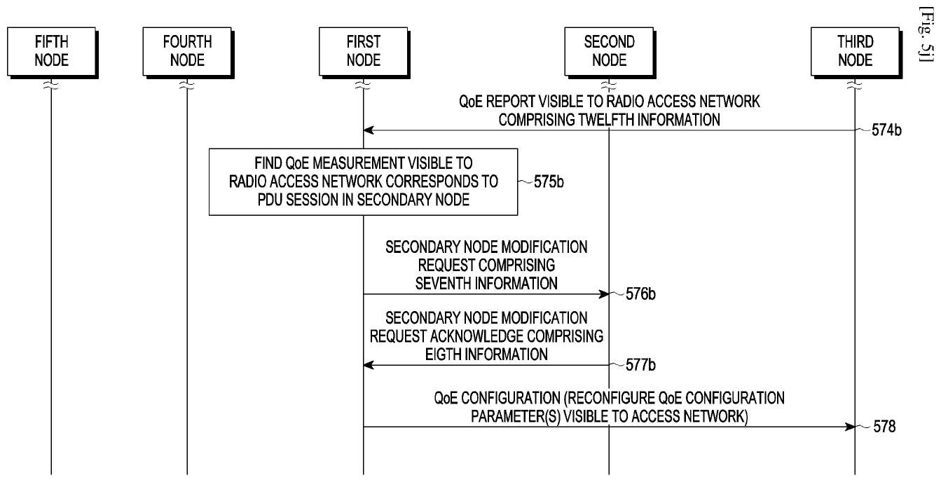

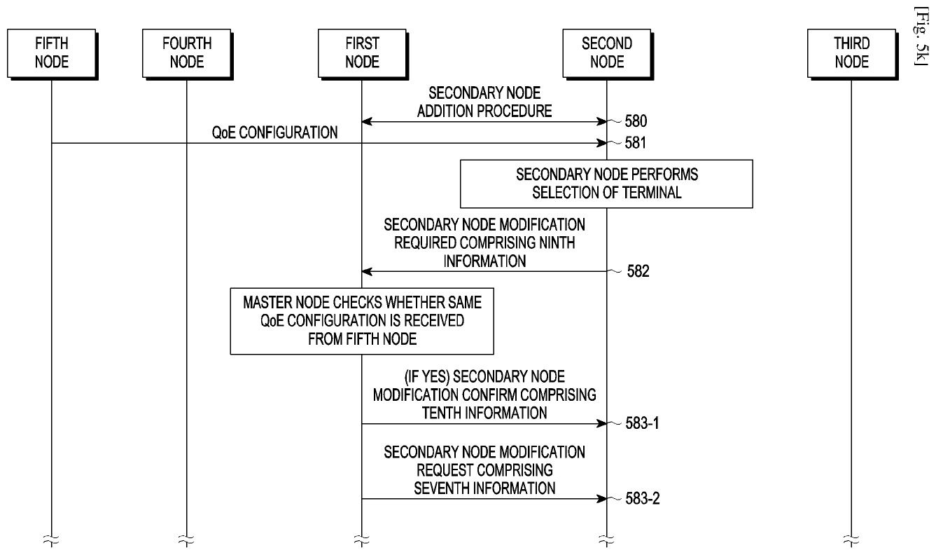

FIG. 5a to FIG. 5l illustrate examples of implementation flows of the concept of the present disclosure in a wireless communication system. Those skilled in the art shall understand that although specific execution steps are illustrated in FIG. 5a to FIG. 5l, the steps in each flow may be performed in combination with each other, or may be performed independently. The steps performed in each flow are just examples, and other possible orders in which the steps are executed are not excluded, such as being executed simultaneously, in reverse order, and the like.

FIG. 5a and FIG. 5b illustrate an example of switching a reporting link/path of a signalling-based Quality of Experience (QoE) measurement.

Referring to FIG. 5a and FIG. 5b, in Step 500, a fifth node may transmit a configuration of QoE to a fourth node.

In Step 501, the fourth node may transmit the configuration of QoE to a first node, and the first node determines, based on the received configuration of QoE, a secondary node should receive QoE report.

In Step 502, the first node may transmit a secondary node addition/modification request message to a second node, which comprises the first information.

In Step 503, the second node may transmits a secondary node addition/modification request acknowledge message to the first node, which comprises the second information.

In Step 504, the first node may transmit the configuration of QoE to a third node, which comprises the fifth information.

In Step 505, the third node may transmit the QoE report to the second node.

In Step 506, the second node may forward the QoE report to a sixth node.

In Step 507, the secondary node may request/require to switch the reporting link/path according to the node status of the secondary node and/or the master node.

In Step 508, the second node may transmit a secondary node modification required message to the first node, which comprises the third information.

In Step 509, the first node may transmit a secondary node modification confirm message to the second node, which comprises the fourth information, and the second node repeats the above steps 4-6 according to the received fourth information, and then the reporting link/path is switched to the master node.

In Step 510, the master node may determine to switch the reporting link/path according to the node status of the master node and/or the secondary node.

In Step 511, the first node may transmit the secondary node modification request message to the second node, which comprises the first information.

In Step 512, the second node may transmit the secondary node modification request acknowledge message to the first node, which comprises the second information, and the first node repeats the above steps 4-6 according to the received second information, and then the reporting link/path is switched to the secondary node.

It should be noted that FIG. 5a and FIG. 5b are only an example, and there is no limitation on the execution order of the steps, especially the sequence of the three pairs of steps, i.e. Steps 502 and 503, Steps 508 and 509, and Steps 511 and 512 is not mandatorily limited in the description.

FIG. 5c illustrates an example of switching a reporting link/path of a management-based QoE measurement(s).

Referring to FIG. 5c, in Step 520, a fifth node may transmit a configuration of QoE to a second node;

In Step 521, the second node may request/require a master node to receive a QoE report according to the received configuration of QoE.

In Step 522, the second node may transmit a secondary node modification required message to the first node, which comprises the third information.

In Step 523, the first node may transmit a secondary node modification confirm message to the second node, which comprises the fourth information, and determine whether the first node or the second node should transmit the configuration of QoE to a third node.

In Step 524, if the master node determines to use the master node to transmit the configuration of QoE to a terminal, the first node may transmit the configuration of QoE to the third node, which comprises the fifth information.

In Step 524′, if the master node determines to use the secondary node to transmit the configuration of QoE to the terminal, the second node may transmit the configuration of QoE to the third node, which comprises the fifth information.

In Step 525, the third node may transmit a QoE report to the first node.

In Step 526, the first node may forward the QoE report to a sixth node.

FIG. 5d illustrates an example of configuration negotiation of a signalling-based QoE measurement(s), involving a core network (in which a master node determines a configuration for QoE measurement).

Referring to FIG. 5d, in Step 530, a first node may interact with a second node, and performs a secondary node addition procedure, and after completion of this procedure, the second node may become the secondary node of the first node.

In Step 530′, a third node may interact with a fourth node, and the core network may acknowledge/confirm that an application layer session has started.

In Step 531, a fifth node transmits a configuration of QoE to the fourth node.

In Step 532, the fourth node may transmit the configuration of QoE to the first node, which comprises the sixth information, and after receiving the sixth information, the first node may determine that the master node should determine a configuration for QoE measurement.

In Step 533, the first node may transmit a secondary node modification request message to the second node, which comprises the seventh information.

In Step 534, the second node may transmit a secondary node modification request acknowledge message to the first node, which comprises the eighth information.

In Step 535, the first node may transmit the configuration of QoE to the third node.

FIG. 5e illustrates a second example of configuration negotiation of a signalling-based QoE measurement(s), involving a core network (in which a secondary node determines a configuration for QoE measurement).

Referring to FIG. 5e, in Step 540, a first node may interact with a second node, and perform a secondary node addition procedure, and after completion of this procedure, the second node may become the secondary node of the first node.

In Step 540′, a third node may interact with a fourth node, and the core network may acknowledge/confirm that an application layer session has started.

In Step 541, a fifth node may transmit a configuration of QoE to the fourth node.

In Step 542, the fourth node may transmit the configuration of QoE to the first node, which comprises the sixth information, and after receiving the sixth information, the first node may determine that the secondary node should determine a configuration for QoE measurement.

In Step 543, the first node may transmit a secondary node modification request message to the second node, which comprises the seventh information.

In Step 544, the second node may transmit a secondary node modification request acknowledge message to the first node, which comprises the eighth information.

In Step 545, the first node may transmit a secondary node reconfiguration complete message to the second node, which comprises the eleventh information.

In Step 546, the first node may transmit the configuration of QoE to the third node.

FIG. 5f illustrates a third example of configuration negotiation of a signalling-based QoE measurement(s), involving a core network (in which a secondary node determines a configuration for QoE measurement).

Referring to FIG. 5f, in Step 550, a first node may interact with a second node, and performs a secondary node addition procedure, and after completion of this procedure, the second node may become the secondary node of the first node;

In Step 550′, a third node may interact with a fourth node, and the core network may acknowledge/confirm that an application layer session has started.

In Step 551, a fifth node may transmit a configuration of QoE to the fourth node.

In Step 552, the fourth node may transmit the configuration of QoE to the first node, which comprises the sixth information, and after receiving the sixth information, the first node may determine that the secondary node should determine a configuration for QoE measurement.

In Step 553, the first node may transmit a secondary node modification request message to the second node, which comprises the seventh information.

In Step 554, the second node may transmit a secondary node modification required message to the first node, which comprises the ninth information.

In Step 555, the first node may transmit a secondary node modification confirm message to the second node, which comprises the tenth information.

In Step 556, the second node may transmit a secondary node modification request acknowledge message to the first node, which comprises the eighth information.

In Step 557, the first node may transmit the configuration of QoE to the third node.

FIG. 5g and FIG. 5h illustrate a first example of configuration negotiation of a signalling-based QoE measurement(s), reported by a terminal (in which an application layer session starts before a configuration of QoE).

Referring to FIG. 5g and FIG. 5h, in Step 560, a first node may interact with a second node, and performs a secondary node addition procedure, and after completion of this procedure, the second node may become the secondary node of the first node.

In Step 560′, a third node may interact with a fourth node, and the core network may acknowledge that an application layer session has started.

In Step 561, a fifth node may transmit a configuration of QoE to the fourth node.

In Step 562, the fourth node may transmit the configuration of QoE to the first node, and the first node may determine a temporary/provisional configuration of QoE visible to the radio access network according to the received configuration of QoE.

In Step 563, the first node may transmit the configuration of QoE to the third node, and the third node, according to the indication in the received configuration of QoE, may subsequently transmit the collected QoE report visible to the radio access network to the secondary node (step 564a) or master node (step 564b).

In Step 564a, the third node may transmit the QoE report visible to the radio access network to the second node according to the indication received in Step 563.

In Step 565a, after receiving the QoE report visible to the radio access network, the second node, according to the information in the report, may determine that the QoE measurement visible to the radio access network corresponds to an protocol data unit session in the master node or the secondary node.

In Step 566a, the second node may transmit a secondary node modification required message to the first node, which comprises the ninth information.

In Step 567a, the first node may transmit a secondary node modification confirm message to the second node, which comprises the tenth information.

In Step 564b, the third node may transmit the QoE report visible to the radio access network to the first node according to the indication received in Step 563.

In Step 565b, after receiving the QoE report visible to the radio access network, the first node may determine that the QoE measurement visible to the radio access network corresponds to the protocol data unit session in the secondary node according to the information in the report.

In Step 566b, the first node may transmit a secondary node modification request message to the second node, which comprises the seventh information.

In Step 567b, the second node may transmit a secondary node modification request acknowledge message to the first node, which comprises the eighth information.

In Step 568, the first node may transmit the configuration of QoE to the third node, so that a terminal reconfigures configuration parameters/metrics of QoE visible to the radio access network.

It should be noted that FIG. 5g and FIG. 5h are only an example, and the execution order of the respective steps is not limited, especially the sequence of the two pairs of Steps 566a and 567a and Steps 566b and 567b is not definitely limited in the description.

FIG. 5i and FIG. 5j illustrate a second example of configuration negotiation of a signalling-based QoE measurement(s), reported by a terminal (in which an application layer session starts after configuration of QoE).

Referring to FIG. 5i and FIG. 5j, in Step 570, a fifth node may transmit a configuration of QoE to a fourth node.

In Step 571, the fourth node may transmit the configuration of QoE to the first node.

In Step 572, the first node may interact with the second node to perform the secondary node addition procedure. After its completion, the second node may become the secondary node of the first node. After the secondary node is added, the first node may determine the temporary/provisional configuration of QoE visible to the radio access network according to the received configuration of QoE.

In Step 573, the first node may transmit the configuration of QoE to the third node, and the third node may subsequently transmit the collected QoE report visible in the access network to the secondary node (step 574a) or master node (step 574b) according to the received indication in the configuration of QoE.

In Step 574a, according to the indication received in Step 573, the third node may transmit the QoE report visible to the radio access network to the second node, which comprises the twelfth information.

In Step 575a, after the second node receives the report of the visible quality of experience of the access network, according to the information in the report, it is determined that the measurement of the quality of experience visible to the radio access network corresponds to the protocol data unit session of the master node or the secondary node.

In Step 576a, the second node may transmit a secondary node modification required message to the first node, which comprises the ninth information.

In Step 577a, the first node may transmit a secondary node modification confirm message to the second node, which comprises the tenth information.

In Step 574b, according to the indication received in Step 573, the third node may transmit the QoE report visible to the radio access network to the first node, which comprises the twelfth information.

In Step 575b, after receiving the QoE report visible to the radio access network, the first node may determine that the measurement of the quality of experience visible to the radio access network corresponds to the PDU session at the secondary node according to the information in the report.

In Step 576b, the first node may transmit a secondary node modification request message to the second node, which comprises the seventh information.

In Step 577b, the second node may transmit a secondary node modification request acknowledge message to the first node, which comprises the eighth information.

In Step 578, the first node may transmit the configuration of QoE to the third node, so that the terminal reconfigures the configuration parameters/metrics of QoE visible to the radio access network.

FIG. 5k and FIG. 5l illustrate a second example of management-based QoE measurement configuration negotiation (in which the secondary node receives the configuration of QoE from the OAM).

Referring to FIG. 5k and FIG. 5l, in Step 580, the first node may interact with the second node, and perform the secondary node addition procedure. After its completion, the second node becomes the secondary node of the first node.

In Step 581, the fifth node may transmit the configuration of QoE to the second node, and the second node may select terminal(s) according to the received configuration of QoE.

In Step 582, the second node may transmit a secondary node modification required message to the first node, which comprises the ninth information. After receiving the ninth information, the first node may check whether the master node received the same configuration of QoE from the fifth node according to the content of the ninth information.

In Step 583-1, if the first node has received the same configuration of QoE from the fifth node, the first node may transmit a secondary node modification confirm message to the second node, which comprises the tenth information.

In Step 583-2 (optional), if the first node has received the same configuration of QoE from the fifth node, the first node may transmit a secondary node modification request message to the second node, which comprises the seventh information.

In Step 583-3 (if step 583-2 has been executed), the second node may transmit a secondary node modification request acknowledge message to the first node, which comprises the eighth information.

In Step 583′, if the first node does not receive the same configuration of QoE from the fifth node, the first node may transmit a secondary node modification confirm message to the second node, which comprises the tenth information.

In Step 584, (if step 583-1 has been executed), the first node or the second node may transmit the configuration of QoE to the third node.

In Step 584′, (if step 583′ has been executed), the second node may transmit the configuration of QoE to the third node.

In order to ensure the continuity of the measurement configuration reporting of the quality of experience supporting dual-connectivity, the present disclosure provides a measurement configuration negotiation method supporting dual-connectivity, which ensures the measurement, collection and reporting of quality of experience being carried out continuously or correctly under the circumstance when mobility (such as handover) of users happens by enhancing information exchange between nodes.

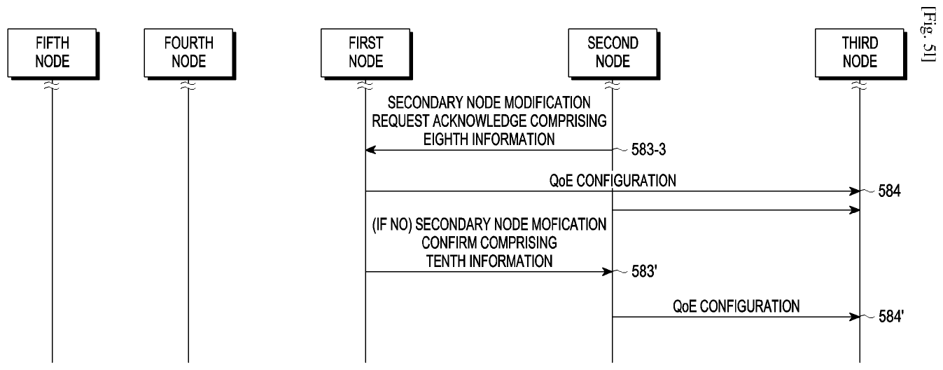

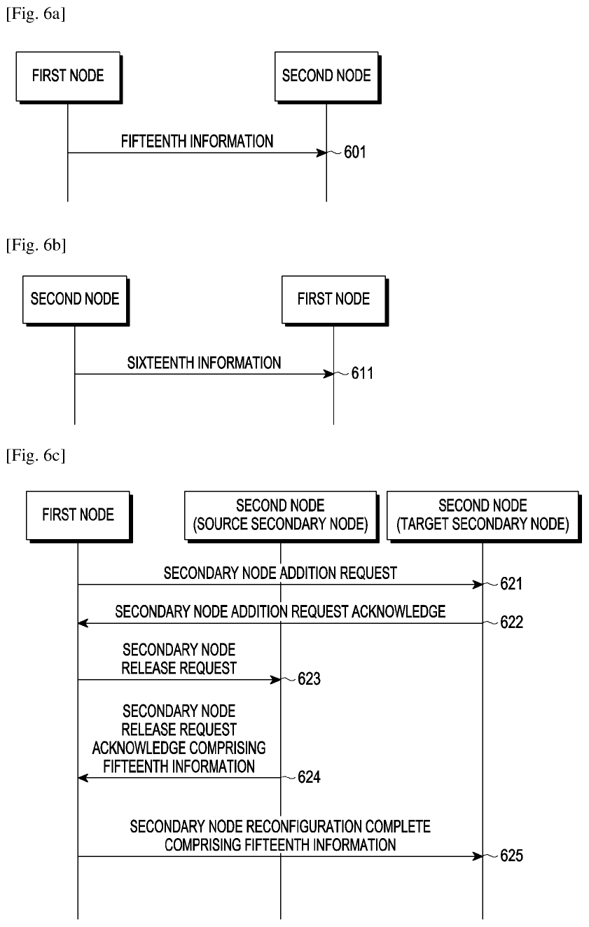

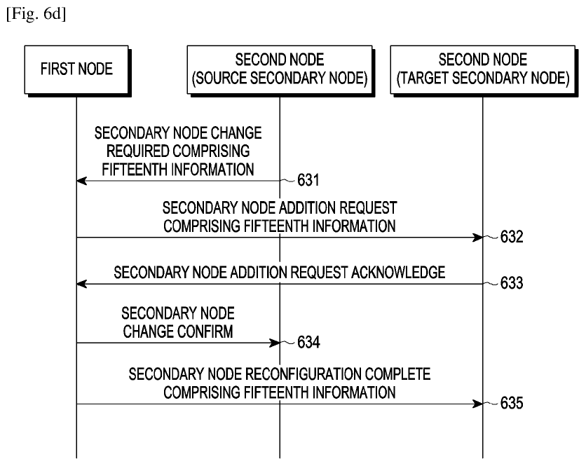

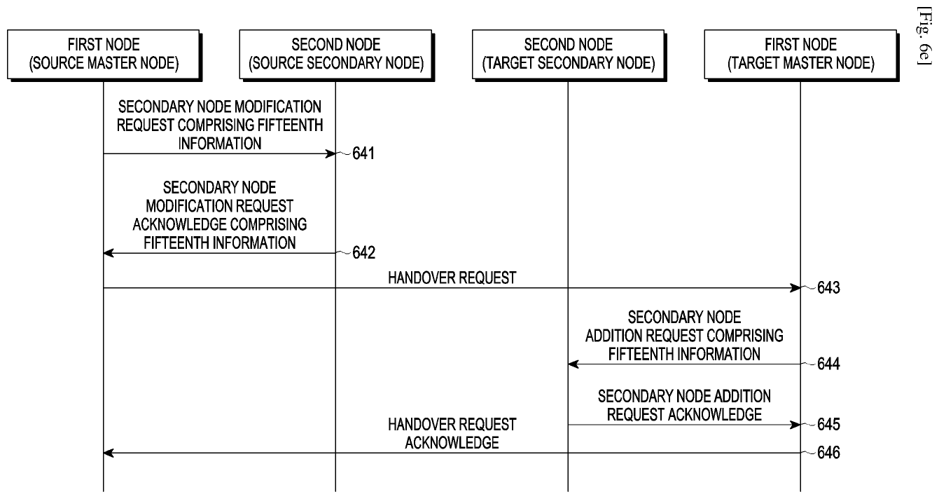

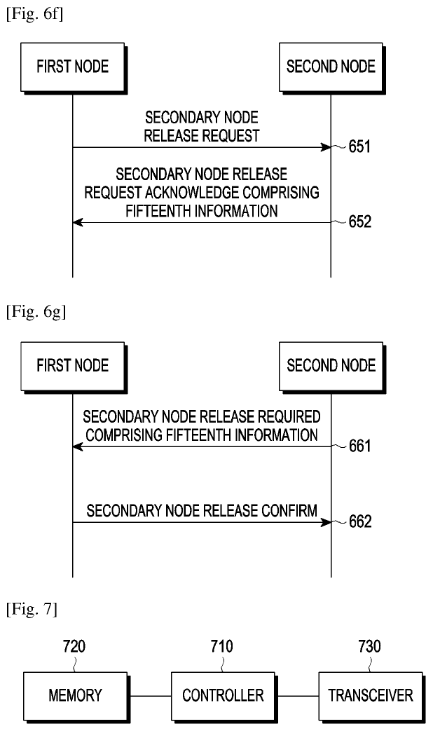

Referring to FIG. 6a or FIG. 6b, the first node may be the master base station (or referred to as master node), or the centralized unit of the master base station/master node, or the control plane part of the master base station/master node's centralized unit, or the source master base station/master node, or the target master base station/master node; the second node may be a secondary base station (or referred to as a secondary node), or a centralized unit of a secondary base station/secondary node, or a control plane part of a centralized unit of a secondary base station/secondary node, or the source secondary base station/secondary node, or the target secondary base station/secondary node; or, the first node may be a secondary base station (or referred to as secondary node), or a centralized unit of the secondary base station/secondary node, or the control plane part of a centralized unit of the secondary base station/secondary node, or the source secondary base station/secondary node, or the target secondary base station/secondary node, the second node may be the master base station (or referred to as the master node), or the centralized unit of the master base station/master node, or the control plane part of the centralized unit of the master base station/master node, or the source master base station/master node, or the target master base station/master node.

As illustrated in FIG. 6a, in step 601, the first node may transmit fifteenth information to the second node, where the fifteenth information may comprise at least one of the following information:
configuration information of QoE; or
request for configuration information of QoE.

The configuration information of QoE described here may comprise at least but not limited to one of the following information:
Quality of Experience Reference (QoE Reference) or Quality of Experience Reference ID;
an application layer configuration ID(s);
a measurement collection entity IP address(es);
a measurement collection entity ID(s);
a service type;
a measurement Status(es) of Quality of Experience;
a configuration container(s) of QoE;
Minimization of Drive Tests Alignment information;
an area scope;
a list of slices; or
available parameter(s)/metric(s) for quality of experience visible to the radio access network.

The fifteenth information may be included in the existing XnAP S-NODE RECONFIGURATION COMPLETE (Xn application protocol secondary node reconfiguration complete) message, in the existing S-NODE ADDITION REQUEST message, in the existing S-NODE MODIFICATION REQUEST message, in the existing S-NODE CHANGE REQUIRED message, in the existing S-NODE MODIFICATION REQUEST ACKNOWLEDGE message, in the existing S-NODE RELEASE REQUEST ACKNOWLEDGE message. Besides, the message may also be included in the existing S-NODE RELEASE REQUIRED message, or in other existing XnAP messages or new XnAP messages.

As illustrated in FIG. 6b, in step 611, the second node may transmit sixteenth information to the first node, where the sixteenth information may comprise at least one of the information elements of the fifteenth information.

Through this way of enhancing information exchange between nodes, it is possible to ensure continuous or correct performance of quality of experience measurement, collection, and reporting in a dual-connectivity scenario.

In FIG. 6c, the first node may be the master base station (or referred to as master node), or the centralized unit of the master base station/master node, or the control plane part of the master base station/master node's centralized unit, or the source master base station/master node.

FIG. 6c illustrates an example of enhanced interface interaction for ensuring continuity of quality of experience measurement in a scenario where a secondary node change is triggered by a master node.

In FIG. 6c, the following steps may be included.

In Step 621, the first node may transmit a secondary node addition request message to the target secondary node.

In Step 622, the target secondary node may transmit a secondary node addition request acknowledge message to the first node.

In Step 623, the first node may transmit a secondary node release request message to the source secondary node.

In Step 624, the source secondary node may transmit a secondary node release request acknowledge message to the first node, which comprises the fifteenth information.

In Step 625, the first node may transmit a secondary node reconfiguration complete message to the target secondary node, which comprises the fifteenth information.

In FIG. 6d, the first node may be the master base station (or referred to as master node), or the centralized unit of the master base station/master node, or the control plane part of the master base station/master node's centralized unit, or the source master base station/master node.

FIG. 6d illustrates an example of interface interaction enhancement for ensuring continuity of quality of experience measurement in a scenario that a secondary node change is triggered by a secondary node.

In FIG. 6d, the following steps may be included.

In Step 631, the source secondary node may transmit a secondary node change required message to the first node, which comprises the sixteenth information.

In Step 632, the first node may transmit a secondary node addition request message to the target secondary node, which comprises the fifteenth information;

In Step 633, the target secondary node may transmit a secondary node addition request acknowledge message to the first node.

In Step 634, the first node may transmit a secondary node change confirm message to the source secondary node.

In Step 635, the first node may transmit a secondary node reconfiguration complete message to the target secondary node, which comprises the fifteenth information.

Please note that in FIG. 6d, Step 632 and Step 635 may be optional, and the above procedure may have any one of Step 632 and Step 635.

FIG. 6e illustrates an example of enhanced interface interaction for ensuring continuity of quality of experience measurement in a scenario where a master node triggers a secondary node to change during master node handover.

In FIG. 6e, the following steps may be included.

In Step 641, the source master node may transmit a secondary node modification request message to the source secondary node, which comprises the fifteenth information.

In Step 642, the source secondary node may transmit a secondary node modification request acknowledge message to the source master node, which comprises the sixteenth information.

In Step 643, the source master node may transmit a handover request message to the target master node.

In Step 644, the target master node may transmit a secondary node addition request message to the target secondary node, which comprises the fifteenth information.

In Step 645, the target secondary node may transmit a secondary node addition request acknowledge message to the target master node.

In Step 646, the target master node may transmit a handover request acknowledge message to the source master node.

In FIG. 6f, the first node may be the master base station (or referred to as master node), or the centralized unit of the master base station/master node, or the control plane part of the master base station/master node's centralized unit, or the source master base station/master node, or the target master base station/master node; the second node may be a secondary base station (or referred to as a secondary node), or a centralized unit of a secondary base station/secondary node, or a control plane part of a centralized unit of a secondary base station/secondary node, or the source secondary base station/secondary node, or the target Secondary base station/secondary node.

FIG. 6f illustrates an example of enhanced interface interaction for ensuring continuity of quality of experience measurement in a scenario where secondary node release is triggered by the master node.

In FIG. 6f, the following steps may be included.

In Step 651, the first node may transmit a secondary node release request message to the second node.

In Step 652, the second node may transmit a secondary node release request acknowledge message to the first node, which comprises the sixteenth information.

In FIG. 6g, the first node may be the master base station (or referred to as master node), or the centralized unit of the master base station/master node, or the control plane part of the master base station/master node's centralized unit, or the source master base station/master node, or the target master base station/master node; the second node may be a secondary base station (or referred to as a secondary node), or a centralized unit of a secondary base station/secondary node, or a control plane part of a centralized unit of a secondary base station/secondary node, or the source secondary base station/secondary node, or the target Secondary base station/secondary node.

FIG. 6g illustrates an example of enhanced interface interaction for ensuring continuity of quality of experience measurement in a scenario where secondary node release is triggered by the secondary node.

In FIG. 6g, the following steps may be included.

In Step 661, the second node may transmit a secondary node release required message to the first node, which comprises the sixteenth information.

In Step 662, the first node may transmit a secondary node release confirm message to the second node.

FIG. 7 illustrates an example of a block diagram of a network node according to an embodiment of the disclosure.

Referring to FIG. 7, a network node (e.g., a first node, a second node, or a third node) may comprises at least one a controller 710, memory 720, or a transceiver 730. The controller 710 may be coupled with the transceiver 730 and configured to perform the operations in the methods as described above.

Those skilled in the art will understand that the above-described illustrative embodiments are described herein and are not intended to be limiting. It should be understood that any two or more of the embodiments disclosed herein may be combined in any combination. Furthermore, other embodiments may be utilized and other changes may be made without departing from the scope of the subject matter presented herein. It will be readily appreciated that the various aspects of the disclosed invention, as generally described herein and illustrated in the accompanying drawings, may be arranged, substituted, combined, separated, and designed in various different configurations, all of which are herein was envisaged.

Those of skill in the art will understand that the various illustrative logical blocks, modules, circuits, and steps described herein can be implemented as hardware, software, or combinations of both. To clearly illustrate this interchangeability of hardware and software, various illustrative components, blocks, modules, circuits, and steps have been described above generally in terms of their function sets. Whether such a feature set is implemented as hardware or software depends on the specific application and design constraints imposed on the overall system. Those skilled in the art may implement the described function sets in varying ways for each particular application, but such design decisions should not be interpreted as causing a departure from the scope of this application.

The various illustrative logical blocks, modules, and circuits described in this application may be implemented or performed in general-purpose processors, digital signal processors (DSPs), application specific integrated circuits (ASICs), field programmable gate arrays (FPGAs) or other programmable logic devices, discrete gates or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, such as a combination of a DSP and a microprocessor, multiple microprocessors, one or more microprocessors cooperating with a DSP core, or any other such configuration.

The steps of a method or algorithm described herein may be embodied directly in hardware, in a software module executed by a processor, or in a combination of the two. A software module may reside in RAM memory, flash memory, ROM memory, EPROM memory, EEPROM memory, registers, hard disk, removable disk, or any other form of storage medium known in the art. An exemplary storage medium is coupled to the processor such the processor can read information from, and write information to, the storage medium. In the alternative, the storage medium may be integrated into the processor. The processor and storage medium may reside in the ASIC. The ASIC may reside in the user terminal. In the alternative, the processor and storage medium may reside in the user terminal as discrete components.

In one or more exemplary designs, the functions may be implemented in hardware, software, firmware, or any combination thereof. If implemented in software, the functions may be stored on or transmitted over as one or more instructions or code in a computer-readable medium. Computer-readable media comprises both computer storage media and communication media comprising any medium that facilitates transfer of a computer program from one place to another. A storage medium can be any available medium that can be accessed by a general purpose or special purpose computer.

The above description is only exemplary embodiments of the present disclosure and is not intended to limit the scope of the present disclosure, which is defined by the appended claims.

1-15. (canceled)

16. A method performed by a master node for a dual connectivity (DC) in a wireless communication system, the method comprising:
transmitting a first message to a secondary node for the DC, the first message including information about quality of experience (QoE) measurement configuration; and
receiving a second message from the secondary node in response to the first message.

17. The method of claim 16, wherein the information about the QoE measurement configuration includes at least one of:
a QoE Reference;
an application layer configuration identifier (ID); or
a measurement collection entity internet protocol (IP) address.

18. The method of claim 16, wherein the information about the QoE measurement configuration comprises information indicating whether a QoE report is reported by the master node or the secondary node.

19. The method of claim 16, wherein the second message includes at least one of:
information about accepting that a QoE report is reported by the master node; or
information about accepting that the QoE report is reported by the secondary node.

20. The method of claim 16, further comprising:
transmitting a third message including information indicating whether a QoE report is reported by the master node or the secondary node to a terminal.

21. The method of claim 16, wherein the first message is a request message for a secondary node addition, and the second message is an acknowledge message for the secondary node addition.

22. The method of claim 16, wherein the first message is a request message for a secondary node modification, and the second message is an acknowledge message for the secondary node modification.

23. The method of claim 16, wherein the first message includes information about QoE configuration visible to a radio access network including at least one of:
information about reporting periodicity;
information about buffer level; and
information about a playout delay for media startup.

24. A master node for a dual connectivity (DC) in a wireless communication system, the master node comprising:
a transceiver; and
at least one processor coupled with the transceiver, wherein the least one processor is configured to:
transmit a first message to a secondary node for the DC, the first message including information about quality of experience (QoE) measurement configuration; and
receive a second message from the secondary node in response to the first message.

25. The master node of claim 24, wherein the information about the QoE measurement configuration includes at least one of:
a QoE Reference;
an application layer configuration identifier (ID); or
a measurement collection entity internet protocol (IP) address.

26. The master node of claim 24, wherein the information about the QoE measurement configuration comprises information indicating whether a QoE report is reported by the master node or the secondary node.

27. The master node of claim 24, wherein the second message includes at least one of:
information about accepting that a QoE report is reported by the master node; or
information about accepting that the QoE report is reported by the secondary node.

28. The master node of claim 24, wherein the at least one processor is further configured to:
transmit a third message including information indicating whether a QoE report is reported by the master node or the secondary node to a terminal.

29. The master node of claim 24, wherein the first message includes information about QoE configuration visible to a radio access network including at least one of:
information about reporting periodicity;
information about buffer level; and
information about a playout delay for media startup.

30. The master node of claim 24, wherein the first message is a request message for a secondary node addition, and the second message is an acknowledge message for the secondary node addition.

31. The master node of claim 24, wherein the first message is a request message for a secondary node modification, and the second message is an acknowledge message for the secondary node modification.
